(19) United States
(12) Patent Application Publication
(10) Pub. No.: US 2026/0253257 A1
(43) Pub. Date: Aug. 27, 2026

(54) SYSTEMS AND METHODS FOR CREASE ATTRIBUTE CODING IN 3D MESHES

(71) Applicant: Tencent America LLC, Palo Alto, CA (US)

(72) Inventors: Shan LIU, Palo Alto, CA (US); Fang-Yi CHAO, Palo Alto, CA (US); Chao HUANG, Palo Alto, CA (US)

(21) Appl. No.: 19/360,878

(22) Filed: Oct. 16, 2025

Related U.S. Application Data
(60) Provisional application No. 63/763,220, filed on Feb. 25, 2025.
(60) Provisional application No. 63/811,475, filed on May 23, 2025.

(51) Int. Cl. G06T 9/00

(52) U.S. Cl. CPC G06T 9/001

(57) ABSTRACT

An example method includes receiving a bitstream associated with a mesh object and parsing a first indicator indicating a number of creases for the mesh object. The method also includes parsing a second indicator indicating a number of vertices for the mesh object. For each crease in the number of creases, the method includes determining whether the crease is an initial crease. When the crease is the initial crease, a prediction residue is parsed. When the crease is not the initial crease, a corresponding prediction residue is selectively parsed based on a predictor index.

### RELATED APPLICATIONS

This application claims priority to U.S. Provisional Patent Application No. 63/763,220, entitled “Description of Crease Attribute,” filed Feb. 25, 2025, and to U.S. Provisional Patent Application No. 63/811,475, entitled “Improved Crease Attribute Coding,” filed May 23, 2025, each of which is hereby incorporated by reference in its entirety.

### TECHNICAL FIELD

The disclosed embodiments relate generally to polygonal mesh coding, including but not limited to systems and methods for sparse vertex and crease coding.

### BACKGROUND

Over time, three-dimensional mesh models have gained support in a variety of electronic applications, such as computer-aided design, virtual reality, augmented reality, digital entertainment, scientific visualization, digital manufacturing, and more. These meshes represent surfaces using vertices, edges, and faces. The mesh data may include surface orientation data, texture coordinates, and vertex information. Due to limited bandwidth capacity of communication networks and limited memory resources of resource-constrained devices, compression methods may be used to reduce mesh data size before streaming or storage. The compression can be performed by hardware and/or software on a local device or a remote server.

Mesh compression typically employs schemes designed to address geometric positions, connectivity, and various attributes, with the goal of compressing data into a form that operates at a reduced bit rate while striving to maintain mesh fidelity. However, attribute compression schemes are frequently optimized for dense per-vertex data, which introduces difficulties in effectively encoding sparse edge attributes such as crease indicators without causing notable bitstream overhead. Current mesh coding frameworks tend to emphasize geometry and connectivity compression, while attribute coding methods have predominantly concentrated on continuous vertex-based data.

One entity developing mesh compression techniques is the Alliance for Open Media Volumetric Visual Media (VVM) Working Group, which is tasked with developing standards and technologies for efficient compression, transmission, and storage of static and dynamic 3D polygonal meshes.

### SUMMARY

The above approaches can result in redundant indexing and limited utilization of edge connectivity patterns, leading to less effective compression efficiency. For example, linear prediction applied to attribute values often provides only modest gains because it fails to capture the categorical and discrete characteristics of crease sequences. As a result, current schemes may allocate up to ten percent or more of the total bitstream to crease data, creating a need for more streamlined and tailored coding solutions that account for mesh topology and reduce overhead for sparse edge attributes.

The present disclosure describes efficient coding of crease attributes in 3D meshes, e.g., by grouping connected creases into linear, branch-free sequences, which allows only the initial vertex of each group to be signaled and subsequent vertices to be predicted based on geometric connectivity. This leverages sparse attribute coding with predictor indexing, where the first vertex of non-initial creases is derived from the last vertex of the previous crease, and other vertices are encoded using prioritized geometric predictors, signaling the prediction residue only when necessary. The approach supports flexible predictor selection and residue signaling, optimizing the bitstream for sparse edge attributes. Additionally, the methods are compatible with multiple mesh formats and attribute types, including crease, line, and hole attributes, enhancing versatility and interoperability. The techniques described herein can provide a significant bitstream reduction while improving compression efficiency, mesh fidelity, and rendering accuracy. Moreover, the techniques are scalable, adaptable to various mesh topologies, and align with industry standards, thereby facilitating broad adoption and integration into diverse 3D applications.

In accordance with some embodiments, a method of mesh decoding includes: (i) receiving a bitstream associated with a mesh object; (ii) parsing a first indicator indicating a number of creases for the mesh object; (iii) parsing a second indicator indicating a number of vertices for the mesh object; and (iv) for each crease in the number of creases: (a) determining whether the crease is an initial crease; (b) when the crease is the initial crease, parsing a prediction residue; and (c) when the crease is not the initial crease, selectively parsing a corresponding prediction residue based on a predictor index.

In accordance with some embodiments, a method of mesh encoding includes: (i) obtaining a mesh object; (ii) signaling, via a bitstream, a first indicator indicating a number of creases for the mesh object; (iii) signaling, via the bitstream, a second indicator indicating a number of vertices for the mesh object; and (iv) for each crease in the number of creases: (a) determining whether the crease is an initial crease; (b) when the crease is the initial crease, signaling, via the bitstream, a prediction residue; and (c) when the crease is not the initial crease, selectively signaling, via the bitstream, a corresponding prediction residue based on a predictor index.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder). In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding mesh objects. Such methods, devices, and systems may complement or replace conventional methods, devices, and systems for mesh encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2 is a block diagram illustrate an example encoding and decoding system in accordance with some embodiments.

FIG. 3 is a block diagram illustrating an example server system in accordance with some embodiments.

FIG. 4 illustrates example objects having creases in accordance with some embodiments.

FIG. 5 illustrates example vertex prediction in accordance with some embodiments.

FIG. 6A illustrates an example mesh decoding process in accordance with some embodiments.

FIG. 6B illustrates an example mesh encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

Mesh coding is a critical technology for the efficient compression, transmission, and storage of three-dimensional (3D) polygonal meshes, which are widely used in applications such as computer-aided design, virtual and augmented reality, digital entertainment, and scientific visualization. Traditional mesh coding methods focus primarily on compressing geometric positions and connectivity, often optimizing for dense per-vertex attributes. However, these approaches struggle to efficiently encode sparse edge attributes, such as crease indicators, resulting in notable bitstream overhead and limited compression efficiency.

The present disclosure addresses these challenges by introducing a set of techniques for crease attribute coding in 3D meshes. An example approach begins with a preprocessing step that groups connected creases into linear, branch-free sequences, enabling the signaling of only the initial vertex in each group and allowing subsequent vertices to be predicted based on geometric connectivity. In some embodiments, sparse attribute coding is further enhanced through predictor indexing, where the first vertex of non-initial creases is derived from the last vertex of the previous crease, and other vertices are encoded using prioritized geometric predictors, with prediction residues signaled only when necessary. The disclosed methods support flexible predictor selection and residue signaling, optimizing the bitstream for sparse edge attributes. Additionally, the techniques are compatible with multiple mesh formats and attribute types, including crease, line, and hole attributes, ensuring broad applicability and interoperability.

### Example Systems and Devices

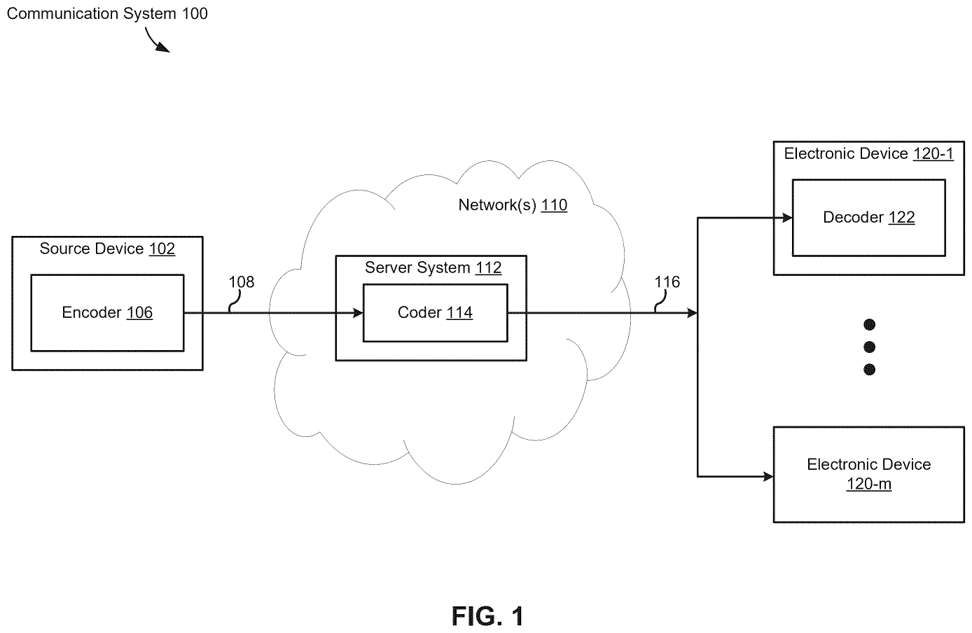

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with applications such as video conferencing applications, digital TV applications, and media storage and/or distribution applications.

The source device 102 includes an encoder component 106. The encoder component 106 generates one or more encoded bitstreams for a set of one or more three-dimensional (3D) objects. The set of 3D objects may be high data volume as compared to the encoded bitstream 108 generated by the encoder component 106. Because the encoded bitstream 108 is lower data volume (less data) as compared to the source objects, the encoded bitstream 108 requires less bandwidth to transmit and less storage space to store as compared to the source objects. In some embodiments, the source device 102 does not include the encoder component 106 (e.g., is configured to transmit uncompressed object data to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute content such as the (encoded) object data from the source device 102). The server system 112 includes a coder component 114 (e.g., configured to encode and/or decode mesh data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded bitstream 108 and re-encode the object data using a different encoding standard and/or methodology to generate encoded data 116. In some embodiments, the server system 112 is configured to generate multiple formats and/or encodings from the encoded bitstream 108. In some embodiments, the server system 112 functions as a Media-Aware Network Element (MANE). For example, the server system 112 may be configured to prune the encoded bitstream 108 for tailoring potentially different bitstreams to one or more of the electronic devices 120. In some embodiments, a MANE is provided separate from the server system 112.

The electronic device 120-1 includes a decoder component 122. In some embodiments, the decoder component 122 is configured to decode the encoded data 116 to generate a set of mesh objects that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded bitstream 108 to the server system 112. For example, the source device 102 may code a set of 3D object. The server system 112 receives the encoded bitstream 108 and may decode and/or encode the encoded bitstream 108 using the coder component 114. For example, the server system 112 may apply an encoding to the object/mesh data that is more optimal for network transmission and/or storage. The server system 112 may transmit the encoded data 116 (e.g., one or more coded bitstreams) to one or more of the electronic devices 120. Each electronic device 120 may decode the encoded data 116 and optionally display the reconstructed objects.

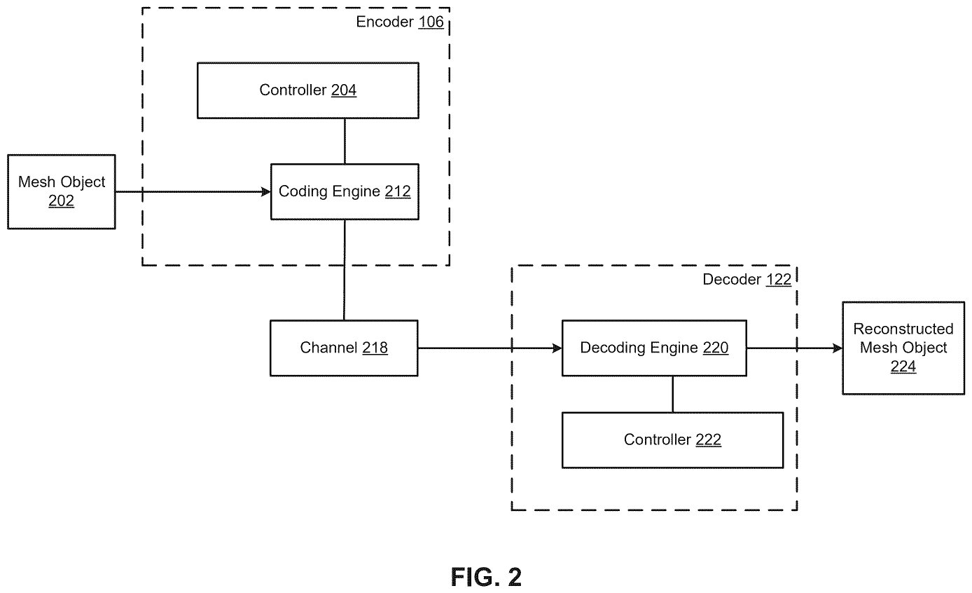

FIG. 2A is a block diagram illustrating example elements of the encoder component 106 and decoder component 122 in accordance with some embodiments. The encoder component 106 receives object data from a source. In some embodiments, the encoder component includes a receiver (e.g., a transceiver) component configured to receive the source data. In some embodiments, the encoder component 106 receives a mesh data from a remote source (e.g., a source that is a component of a different device than the encoder component 106). In some embodiments, the source is a storage device storing previously captured/prepared object data.

The encoder component 106 is configured to code and/or compress the object data in real-time or under other time constraints as required by the application. In some embodiments, the encoder component 106 is configured to perform a conversion between the source data and a bitstream of mesh data. Enforcing appropriate coding speed is one function of a controller 204. In some embodiments, the controller 204 controls other functional units as described below and is functionally coupled to the other functional units. Parameters set by the controller 204 may include parameters such as rate-control-related parameters. The controller 204 may manage coding operations of the source coder 202, including, for example, setting of parameters and subgroup parameters used for encoding the object data. A person of ordinary skill in the art can readily identify other functions of controller 204 as they may pertain to the encoder component 106 being optimized for a certain system design.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

The output of the coding engine 212 may be subjected to entropy coding. An entropy coder may translate the symbols as generated by the various functional units into a coded bitstream, by losslessly compressing the symbols according to technologies known to a person of ordinary skill in the art (e.g., Huffman coding, variable length coding, and/or arithmetic coding). In some embodiments, an output of the entropy coder 214 is coupled to a transmitter. The transmitter may be configured to buffer a coded sequence(s) as created by the entropy coder to prepare them for transmission via a communication channel 218, which may be a hardware/software link to a storage device which would store the encoded data. The transmitter may be configured to merge coded data from with other data to be transmitted, for example, coded audio data and/or ancillary data streams (sources not shown). In some embodiments, the transmitter may transmit additional data with the encoded object data. The encoder 106 may include such data as part of the coded sequence.

The encoder component 106 may perform coding operations according to a predetermined mesh coding technology or standard, such as any described herein. In its operation, the encoder component 106 may perform various compression operations. The coded data, therefore, may conform to a syntax specified by the coding technology or standard being used.

The decoder component 122 in FIG. 2 is coupled to the channel 218. In some embodiments, the decoder component 122 includes a transmitter configured to transmit data to a display or storage device (e.g., via a wired or wireless connection). In some embodiments, the decoder component 122 includes a receiver coupled to the channel 218 and configured to receive data from the channel 218 (e.g., via a wired or wireless connection). The receiver may be configured to receive one or more coded sequences (e.g., bitstreams) to be decoded by the decoder component 122. In some embodiments, the decoding of each coded sequence is independent from other coded sequences. Each coded sequence may be received from the channel 218, which may be a hardware/software link to a storage device which stores the encoded data. The receiver may receive the encoded data with other data, for example, coded audio data and/or ancillary data streams, that may be forwarded to their respective using entities (not depicted). The receiver may separate the coded sequence from the other data. In some embodiments, the receiver receives additional (redundant) data with the encoded data. The additional data may be included as part of the coded sequence(s). The additional data may be used by the decoder component 122 to decode the data and/or to more accurately reconstruct the original data.

In some embodiments, the decoder component 122 includes a buffer memory, a parser (also sometimes referred to as an entropy decoder), a decoding engine 220, and a controller 222. In some embodiments, the decoder component 122 is implemented as an integrated circuit, a series of integrated circuits, and/or other electronic circuitry. The decoder component 122 may be implemented at least in part in software. Buffer memory may be coupled in between the channel 218 and the parser (e.g., to combat network jitter). In some embodiments, the buffer memory is separate from the decoder component 122. In some embodiments, a separate buffer memory is provided between the output of the channel 218 and the decoder component 122. In some embodiments, a separate buffer memory is provided outside of the decoder component 122 in addition to buffer memory inside the decoder component 122 (e.g., which is configured to handle playout timing). When receiving data from a store/forward device of sufficient bandwidth and controllability, or from an isosynchronous network, the buffer memory may not be needed, or can be small. For use on best effort packet networks such as the Internet, the buffer memory may be required, can be comparatively large and/or of adaptive size, and may at least partially be implemented in an operating system or similar elements outside of the decoder component 122.

The parser may be configured to reconstruct symbols from the coded sequence. The symbols may include, for example, information used to manage operation of the decoder component 122, and/or information to control a rendering device such as the display 124. The parser parses (entropy-decodes) the coded sequence. The coding of the coded sequence can be in accordance with a mesh coding technology or standard, and can follow principles well known to a person skilled in the art, including variable length coding, Huffman coding, arithmetic coding with or without context sensitivity, and so forth. The parser 254 may extract from the coded sequence, a set of subgroup parameters for at least one of the subgroups of pixels in the video decoder, based upon at least one parameter corresponding to the group.

Reconstruction of the symbols can involve multiple different units depending on the type of the coded object or parts thereof, and other factors. Which units are involved, and how they are involved, can be controlled by the subgroup control information that was parsed from the coded sequence by the parser. The decoder component 122 can be conceptually subdivided into a number of functional units, and in some implementations, these units interact closely with each other and can, at least partly, be integrated into each other. However, for clarity, the conceptual subdivision of the functional units is maintained herein.

The decoder component 122 may perform decoding operations according to a predetermined mesh compression technology that may be documented in a standard, such as any of the standards described herein. The coded sequence may conform to a syntax specified by the compression technology or standard being used, in the compression technology document or standard and specifically in the profiles document therein. Also, for compliance with some compression technologies or standards, the complexity of the coded sequence may be within bounds as defined by the level of the compression technology or standard. Limits set by levels can be further restricted through Hypothetical Reference Decoder (HRD) specifications and metadata for HRD buffer management signaled in the coded sequence.

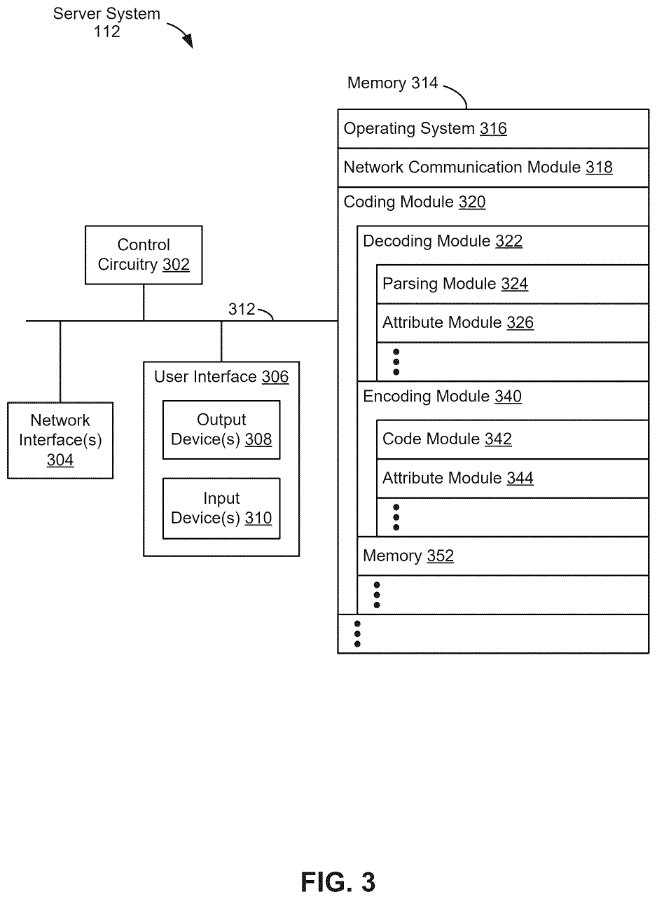

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as object/mesh data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a memory 352 for storing object and/or mesh data, e.g., for use with the coding module 320. In some embodiments, the memory 352 includes one or more of a reference memory and a buffer memory.

In some embodiments, the decoding module 322 includes a parsing module 324 (e.g., configured to perform the various functions described previously with respect to the parser 254) and an attribute module 326 (e.g., configured to decode attributes associated with vertices, or faces of a dynamic mesh from an attribute bitstream (e.g., attribute decoding)).

In some embodiments, the encoding module 340 includes a code module 342 (e.g., configured to perform the various functions described previously with respect to the coding engine 212) and an attribute module 344 (e.g., configured to encode attributes associated with vertices, or faces of a dynamic mesh into an attribute bitstream). In some embodiments, the decoding module 322 and/or the encoding module 340 include a subset of the modules shown in FIG. 3. For example, a shared attribute module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods. In some embodiments, the source device 102 and/or an electronic device 120 may have the same (or a subset of) the components shown and/or described for the server system 112.

### Example Coding Techniques

The coding processes and techniques described below may be performed at the devices and systems described above (e.g., the source device 102, the server system 112, and/or the electronic device 120). The techniques described herein may be used for various mesh coding applications. As described herein, dynamic mesh coding includes both encoding and decoding a dynamic mesh. The present disclosure describes various systems and techniques for attribute coding amongst other things.

Attribute coding in the context of 3D mesh compression involves the representation and transmission of supplementary data associated with mesh elements, such as vertices, edges, faces, or corners. These attributes can include vertex colors, surface normals, texture coordinates, and discrete indicators like creases or lines, all of which are essential for accurate rendering and interpretation of 3D models. In some mesh coding systems, attribute coding is optimized for dense, per-vertex data, where each vertex is assigned a continuous value for attributes such as color or normal direction. This approach works well for attributes that are uniformly distributed across the mesh but becomes inefficient when dealing with sparse or categorical attributes, such as crease indicators, which are only present on a subset of edges.

Within the framework of the Alliance for Open Media Volumetric Visual Media (VVM) Working Group, attribute coding is a key area of innovation and standardization. VVM aims to support a wide range of mesh types and application scenarios, including those requiring lossless and lossy compression of both geometry and attributes. The VVM standard describes efficiently coding not only dense attributes but also sparse edge attributes, which are increasingly relevant for high-fidelity rendering in applications like digital entertainment, scientific visualization, and virtual reality.

The attribute coding techniques described below are well-suited to the requirements and goals of VVM. By grouping connected sparse attributes, such as creases, into linear, branch-free sequences, and leveraging geometric predictors for efficient signaling, the methods dramatically reduce the bitstream overhead associated with these attributes. Predictor indexing and selective residue signaling further optimize the representation, ensuring that only necessary information is transmitted. This results in a more compact bitstream, improved compression efficiency, and enhanced mesh fidelity, all of which are critical for meeting the performance and interoperability targets set by VVM. Moreover, the proposed attribute coding methods are compatible with multiple mesh formats supported by VVM, such as OBJ, PLY, and USD, and can be applied to various attribute types, including creases, lines, and holes.

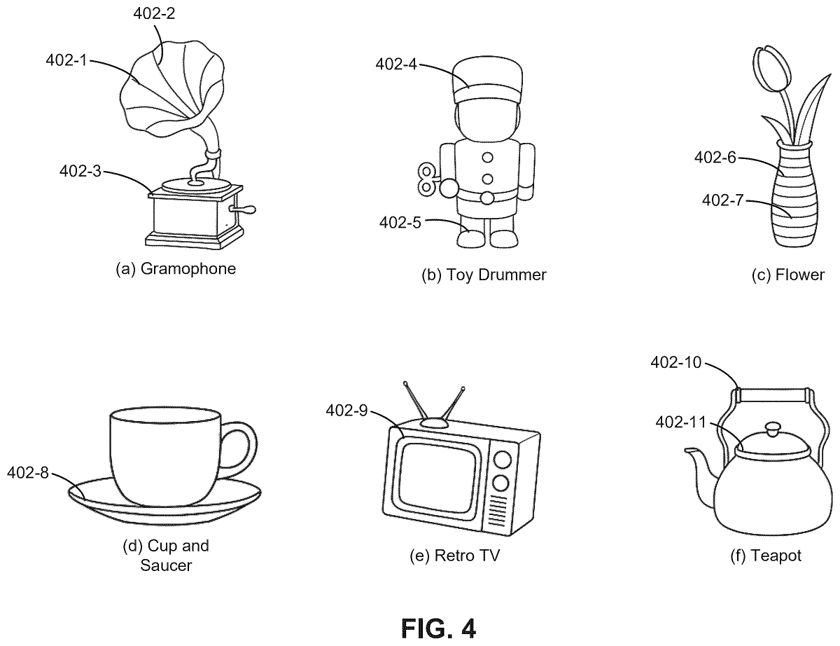

FIG. 4 illustrates example objects having creases in accordance with some embodiments. In FIG. 4, objects (a)-(f) are illustrated with indication of respective creases 402, including creases 402-1, 402-2, 402-3 on the gramophone, creases 402-4 and 402-5 on the toy drummer, creases 402-6 and 402-7 on the flower, crease 402-8 on the cup and saucer, crease 402-9 on the television, and creases 402-10 and 402-11 on the teapot. In accordance with some embodiments, FIG. 4 shows the visualization of a crease attribute in Class G.

The crease attribute (also sometimes referred to as a line attribute or sparse edge) is one of the essential attributes in a 3D mesh that identifies edges to be creased. Crease attributes are specified by a series of vertex indices that denote the successive edges creased by a specific sharpness. Described below are techniques for efficiently coding the crease attributes. Note that the techniques can also be applied to line/hole attributes. The process for coding crease attributes can be divided into two parts: preprocessing (e.g., crease grouping) and coding of the crease attributes.

In some embodiments, the crease attribute is composed of vertex indices to indicate the edges that need to be creased. In some embodiments, the crease attribute is coded as follows: (i) concatenate the indices of all the creases into a single index array, and code each index by signaling the difference between the delta index and the last delta index, where the delta index is the current index minus the previous index; and (ii) the number of vertices in each crease is represented as crease attribute values. These values are coded by applying predictions and signaling the prediction residuals. The last four encoded attribute values are utilized to predict the current attribute value.

In some embodiments, a technique for crease attribute coding is based on adjacent vertices. This technique includes three parts, which are crease grouping, crease attribute coding, and vertex prediction for crease attribute coding. Because the crease attributes are composed of connected edges, the creases may be grouped to make the last vertex of a crease the same as the first vertex of the next crease. The purpose of this crease grouping is to connect as many creases as possible into a line, and this line does not have branches. Therefore, only the initial vertex in each crease group may be signaled, and the remaining vertices may be predicted based on geometric connectivity.

The following are example steps for completing the crease grouping: (i) for all the creases, flip the crease if its first vertex is bigger than the last vertex; (ii) sort the creases in ascending order by the first vertex; (iii) find the first unused crease in the table and mark this crease as used; (iv) Take the last vertex of the found crease and find the unused crease in the table whose first vertex is the same as this vertex. Mark the found crease as used. If no unused creases can be found, find the unused crease whose last vertex is the same as this vertex. Flip this crease and mark the found crease as used. Repeat step (iv) until no unused creases can be found. All the creases found in this step belong to a group. Repeat the last 2 steps until all the creases are used. Table 1, below, illustrates example crease attributes before and after grouping. Note that mesh compare may also be updated to allow reordering and flipping of the crease.

TABLE 1
Crease Attribute Grouping

| Before Grouping | After Grouping |
|---|---|
| 1 8032 7936 7921 7913 7914 | 1 7914 7913 7921 7936 8032 |
| 1 8056 8050 8044 8038 8032 | 1 8032 8038 8044 8050 8056 |
| 1 8080 8074 8068 8062 8056 | 1 8056 8062 8068 8074 8080 |
| 1 8104 8098 8092 8086 8080 | . . . |
| 1 8128 8122 8116 8110 8104 | 1 8873 8874 |
| . . . | 1 8874 8875 |
| 1 8875 8876 | 1 8875 8876 |
| 1 8874 8875 | . . . |
| 1 8873 8874 | 1 13662 13663 13675 13694 13721 |
| 1 8952 8873 | 1 13721 13720 13719 13718 13791 |
| 1 8880 8881 8882 8883 8884 | 1 13791 13825 13836 13869 13906 |
| . . . | . . . |

After grouping the creases into crease groups, two parts of the crease attributes may be to be coded, e.g., the number of vertices in each crease, and the vertices in each crease. The number of creases, the number of vertices in all creases, and the minimum number of vertices in all creases may be encoded. For each crease, the number of vertices within the crease minus the minimum number of vertices in all creases may be encoded, and, whether this crease is the initial crease (e.g., the first crease) in the crease group is encoded. The number of vertices for the last crease need not be signaled, as it can be derived from the total number of vertices of all creases minus the sum of the number of vertices from the first crease to the second-to-last crease.

As an example, for each vertex in the creases, if the vertex being coded is the initial vertex in a crease group (e.g., the first vertex in the initial crease in a crease group), the first vertex of the previous crease group may be used as a predictor and the prediction residue is encoded. In this example, if the vertex being coded is not the initial vertex in a crease group but is the first vertex in a crease, e.g., the first vertex in the non-initial crease, it is not encoded; instead, it is derived by duplicating the last vertex in the previous crease. In this example, if the vertex being coded is not the initial vertex in a crease group nor the first vertex in a crease, the predictors of this vertex are computed. The connected vertices of the previous vertex is used to predict the current vertex, and “−1” is used as a predictor index to indicate that the current vertex is not connected to the previously encoded vertex. The predictor index is encoded, and if the predictor index is smaller than 0, the residue of the prediction value is encoded to the index value of the vertex being encoded. Example syntax are shown in Table 2 below.

TABLE 2
Example Crease Syntax

| | Descriptor |
|---|---|
| crease_syntax( ) { | |
| num_crease_minus1 | ue(v) |
| num_vertex_minus1 | ue(v) |
| min_num_vertex_crease | ue(v) |
| for( i = 0; c = 0; c <= num_crease_minus1; ++c ) { | |
| is_initial_crease | u(1) |
| if( c < num_crease_minus1 ) | |
| num_vertex_crease_minus_min[ c ] | ue(v) |
| if( is_initial_crease ) { | |
| pred_residue | se(v) |
| } | |
| EndIndex = i + num_vertex_crease_minus_min[ c ] + | |
| min_num_vertex_crease; | |
| for( ++i; i < EndIndex; ++i ) { | |
| predictor_index | se(v) |
| if( predictor_index < 0 ) | |
| pred_residue | se(v) |
| } | |
| } | |
| } | |

In accordance with some embodiments: (i) num_crease_minus1 specifies the total number of creases minus 1; (ii) num_vertex_minus1 specifies the total number of vertices in all the creases minus 1; (iii) min_num_vertex_crease specifies the minimum number of vertices of all the creases (e.g., in Table 2, min_num_vertex_crease is 2); (iv) num_vertex_crease_minus_min[c] specifies the number of vertices minus (min_num_vertex_crease) in the cth crease (e.g., in Table 2, num_vertex_crease_minus_min[0] is 3); (v) is_initial_crease specifies if the cth crease is the first crease in a crease group. It is “1” (or “true”) if the cth crease is the first crease in a crease group, and it is “0” (or “false”) if the cth crease is not the first crease in a crease group (e.g., in Table 2, the is_initial_crease of the first crease is 1, and the is_initial_crease of the second crease is 0; (vi) predictor_index specifies the predictor index of one of the predictors used to predict the vertex in the crease. If it is “−1”, it indicates that no predictors result in zero residue; and (vii) pred_residue specifies the residue of the prediction value of predictor_index to the vertex in the crease.

Because crease attributes are composed of multiple successive edges, the geometry connectivity of the vertex may be used to predict the index of the next vertex in the crease. In some embodiments, some criteria are applied to prioritize the predictors for reducing the bits spent on coding the predictor index.

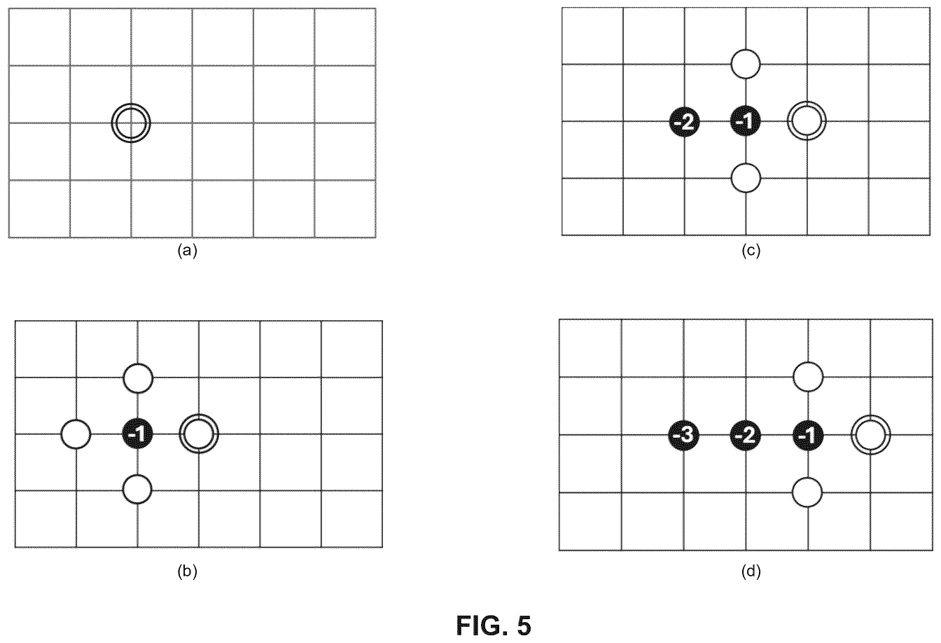

FIG. 5 illustrates example vertex prediction in accordance with some embodiments. As illustrated in FIG. 5(a), for an initial vertex in a crease group, the first vertex in the previous crease group may be used as a predictor. For the second vertex in the crease, all of the connected vertices of the previous vertex (denoted as “−1” in FIG. 5(b)) are predictors. For the third vertex in the crease, all of the connected vertices of the previous vertex (“−1” in FIG. 5(c)) are predictors. A priority is increased (e.g., +1) if the vertex is not in the same face with the previous vertex (−2). The priority is decreased (e.g., −1) if the vertex is the previous vertex (−2).

For the vertex after the third vertex encoded in the crease, all of the connected vertices of the previous vertex (“−1” in FIG. 5(d)) are predictors. A priority is increased (e.g., +1) if the vertex is not in the same face with the previous vertex (−2). The priority is decreased (e.g., −1) if the vertex is the previous vertex (−2). The priority is increased (e.g., +1) if the vertex has a similar angle to the previous angle (e.g., the angle between vertex −1, −2, −3).

The priority scores given by each criterion may be summed and the predictor with the highest score is assigned the smallest predictor index, and the predictor with the second highest score is assigned the second smallest predictor index, and so on.

The techniques described above may be implemented as a vertex-based attribute indices coding strategy in the software. SparseAttributeCreaseIndicesEncoder/Decoder and SparseAttributeCreaseIndicesPredictor may be added for the crease attribute coding.

The input to this process is a bitstream of the crease attributes. The output of this process is an array of the numbers of vertices in each crease and an array of the vertices in all creases.

The decoding process decodes the number of creases minus one, the number of vertices in all creases minus one, and the minimum number of vertices in all creases.

For each crease, if the crease is not the last crease, it decodes the number of vertices of the crease minus the minimum number of vertices of all creases. If the crease is the last crease, the number of vertices of the crease minus the minimum number of vertices of all creases is derived by the total number of vertices in all creases minus the sum of the number of vertices of all previous creases minus the minimum number of vertices in all creases.

For decoding the first vertex in the crease, it decodes if the crease is the initial crease. If yes, it decodes the prediction residue and derives the index of the first vertex in this crease by adding the residue to the index of the first vertex in the previous crease group. It updates the previous initial vertex with this derived vertex index. If no, which means the crease is not the initial crease, it derives the index of the first vertex in this crease by using the index of the last vertex. Then, it updates the index of the last vertex with the derived vertex index.

To decode the remaining vertices in the crease, specifically from the second to the last vertex, it computes the predictors and decodes the predictor index. If the predictor index is bigger than or equal to zero, the index of the vertex is equal to the prediction of the predictor index. If the predictor index is smaller than zero, it means that no predictions have zero residual results. It decodes the prediction residue and adds it to the index of the last vertex to derive the index of the vertex.

Snippet 1 - Example Crease Indices Coding

LastVertex = −1; // the index of the last vertex
PrevInitVertex = 0; // the index of the first vertex in the previous crease group
IndexCounter = 0; // the sum of the number of vertices of previous creases
for( i = 0, c = 0; c <= num_crease_minus1; ++c ) {
if( c < num_crease_minus1 ) {
IndexCounter += num_vertex_crease_minus_min[ c ] + min_num_vertex_crease;
} else {
num_vertex_crease_minus_min[ c ] = num_vertex_minus1 + 1 − IndexCounter −
min_num_vertex_crease;
}
if( is_initial_crease ) {
index_vertex_crease[ i ] = PrevInitVertex + pred_residue;
PrevInitVertex = index_vertex_crease[ i ];
} else {
index_vertex_crease[ i ] = LastVertex;
}
LastVertex = index_vertex_crease[ i ];
EndIndex = i + num_vertex_crease_minus_min[ c ] + min_num_vertex_crease;
for( ++i; i < EndIndex; ++i ) {
ComputePredictors( Predictions );
if( predictor_index >= 0 ) {
index_vertex_crease[ i ] = Predictions[ predictor_index ];
} else {
index_vertex_crease[ i ] = LastVertex + pred_residue;
}
LastVertex = index_vertex_crease[ i ];
}
}

The example process in Snippet 2 below generates a set of predictors that predict the value of a vertex in the crease attribute. The number of predictions depends on the number of adjacent vertices (e.g., AdjVerticesCount). In Snippet 2, vertex0 refers to the last vertex, vertex1 refers to the second-to-last vertex, vertex2 refers to the third-to-last vertex. pos0 refers to the position of vertex0, pos1 refers to the position of vertex1, pos2 refers to the position of vertex2, and pos refers to the position of the current vertex.

Snippet 2 - Example Predictor Set Coding

computePredictors( Predictions ) {
AdjacentVertices = findAdjacentVertices( vertex0 );
for( i=0; i< AdjVerticesCount; i++ ) {
if( AdjacentVertices[ i ] is not in the same face with vertex1 ) {
priority[ i ] += 1
}
if( AdjacentVertices[ i ] == vertex2 ) {
priority[ i ] −= 1
}
if( vertex2 >=0 ) {
angle0 = computeApproximateDiamondAngle(pos0 − pos1, pos2 − pos1);
angle = computeApproximateDiamondAngle(pos − pos0, pos1 − pos0);
if( angle >= angle0 − 2 && angle <= angle0 + 2 ) {
priorities[ i ] += 1;
}
}
}
for( i = 0; i < adjVertexCount; ++i ) {
priorityVertex[ i ] = { priorities[ i ], adjVertices[ i ] };
}
sort( priorityVertex, [ ] (p, q) { return p.first > q.first;} );
for( i = 0; i < adjVertexCount; ++i ) {
Predictions[ i ] = priorityVertex[ i ].second;
}
}

The techniques described above provide a coding gain of 90.74% for the crease attribute and 10.05% for the total bitstream in a generic configuration. They yield a coding gain of 90.48% for the crease attribute and 9.85% for the total bitstream in a per-sequence configuration. Additionally, the percentage of the crease attribute in the total bitstream decreases from 11% to 1.1%.

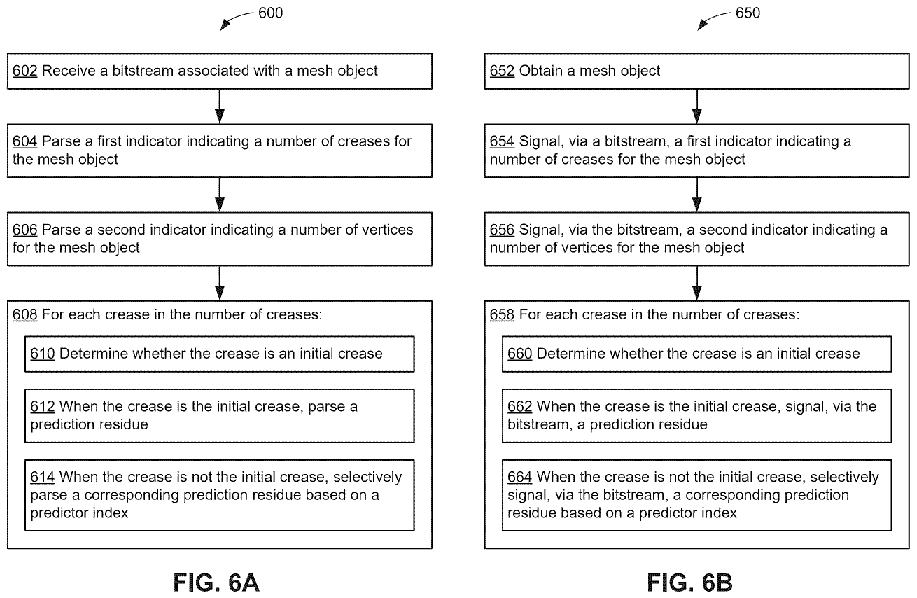

FIG. 6A is a flow diagram illustrating a method 600 of decoding a bitstream in accordance with some embodiments. The method 600 may be performed at a computing system (e.g., the server system 112, the source device 102, or the electronic device 120) having control circuitry and memory storing instructions for execution by the control circuitry. In some embodiments, the method 600 is performed by executing instructions stored in the memory (e.g., the memory 314) of the computing system.

The system receives (602) a bitstream associated with a mesh object. The system parses (604) a first indicator indicating a number of creases for the mesh object. The system parses (606) a second indicator indicating a number of vertices for the mesh object. For each crease in the number of creases (608): the system determines (610) whether the crease is an initial crease. When the crease is the initial crease, the system parses (612) a prediction residue. When the crease is not the initial crease, the system selectively parses (614) a corresponding prediction residue based on a predictor index. In this way, crease information may be parsed from a bitstream (e.g., an attribute bitstream for a set of mesh objects).

In some embodiments, the crease information is described by a sharpness and a set of indices that identify the edges to be creased. In some embodiments, each crease is represented in a line that consists of sharpness, and a set of indices identifying the edge. In some embodiments, an element (e.g., the element “c” in Table 3 below) is used to indicate the crease information. The first number after the element may be the sharpness of the creased edge, and the rest of the numbers in the line may be the vertex indices identifying the edge.

TABLE 3
Example Crease Information Formatting

v 0 0 0
v 0 0 1
v 0 1 1
v 0 1 0
v 1 1 0
v 1 0 0
v 1 0 1
v 1 1 1
f 1 2 3 4
f 1 4 5 6
f 1 6 7 2
f 2 7 8 3
f 3 8 5 4
f 8 7 6 5
c 120 1 2 7 8 5 6 1
c 80 2 3 8 2
c 150 1 4 5 6 1

In various embodiments, the sharpness is represented by a quantized number, an integer, a decimal number, or any mapping number. Note that the format of the crease information can be one of the following:

TABLE 4
Example Crease Information Formatting

c sharpness the_indices_of_vertices
c the_indices_of_vertices sharpness
c sharpness idx_1 idx_2 . . . idx_n
c idx_1 idx_2 . . . idx_n sharpness
c idx_1 idx_2 . . . idx_n

where the_indices_of_vertices is an array of integers to specify a set of vertex indices that form the crease. Note that the line of the crease information can start with letters other than “c”. In some embodiments, only the indices identifying the crease are present in the description. For example, a user can indicate the sharpness of the crease by other means.

Table 5 below provides an example of the crease attribute, where the three creases are defined in the lines beginning with the letter “l”. The elements following the letter “l” represents the indices of the vertices, which start with the letter “v”. Specifically, the “l” after the letter “l” indicates the first vertex starting with “v” (e.g., 0 0 0), and the next number “2” signifies the second vertex starting with “v” (e.g., 0 0 1). Note that the crease attributes can be represented in many mesh formats, like USD, PLY, etc.

TABLE 5
Example Crease Information Formatting

v 0 0 0
v 0 0 1
v 0 1 1
v 0 1 0
v 1 1 0
v 1 0 0
v 1 0 1
v 1 1 1
f 1 2 3 4
f 1 4 5 6
f 1 6 7 2
f 2 7 8 3
f 3 8 5 4
f 8 7 6 5
I 1 2 7 8
I 4 5 6
I 3 2
I 3 8 7
I 8 5
I 7 8 3 4 5

In some embodiments, a crease grouping step groups connected creases and counts the number of creases in each group. Two connected creases indicate that the last vertex of one crease is the same as the first vertex of the other crease. For example, in Table 5, the first crease is connected to the 5th crease. Note that a crease can be flipped, e.g., changing the order of each vertex to the opposite of the original. For example, in Table 5, the first crease can be flipped to “8 7 2 1.” Crease grouping is used to connect as many creases as possible into a line, and this line does not have any branches. Therefore, the system only needs to signal the predictor index and/or residue for the first vertex in the crease group, and signal the predictor index and/or residue for the remaining vertices in the same crease group.

In some embodiments, the following steps are used for completing the crease grouping. Step 0: For all the creases, flip the crease if its first vertex is bigger than the last vertex. Step 1: For all the creases, take the first and the last vertex of a crease to represent the start point and the end point of this crease, and make a table for this information, and mark all the creases as unused. Step 2: Sort the creases in ascending order by the first vertex. Step 3: Find the first unused crease in the table. Mark this crease as used. Step 4: Take the last vertex of the found crease and find the unused crease in the table whose first vertex is the same as this vertex. Mark the found crease as used. Step 5: If no unused creases in the table can be found, find the unused crease in the table whose last vertex is the same as this vertex (e.g., the vertex mentioned in Step 4). Flip this crease and mark the found crease as used. Step 6: Repeat Steps 4 to 5 until no unused creases in the table can be found. Step 7: Group all the creases found in Steps 1 through 6 into a single crease group. Step 8: Repeat Steps 3 to 7 until no unused creases on the table, e.g., all the creases are used.

After these grouping procedures, the system can group all the connected creases into a crease group, and get the total number of crease groups and the number of creases in each crease group. For example, Table 6 shows the crease attributes in Table 5 after grouping.

TABLE 6
Crease attributes of Table 5 after grouping

I 1 2 7 8
I 8 5
I 5 4 3 8 7
I 7 8 3
I 3 2
I 4 5 6

There are two crease groups in Table 6, where the first to the 5^{th} creases belong to the first crease group, and the 6^{th} crease belongs to the second crease group. The first crease group has 5 creases, and the second crease group has 1 crease.

After crease grouping, the system finds the initial vertex (e.g., the first vertex) in the crease group by checking if it is the same as the last vertex in the previous crease. The system signals the information to indicate the initial vertex in the crease group in the bitstream.

In some embodiments, the system counts the number of creases in the crease group and counts the number of crease groups. The system signals the information to indicate the first vertex (e.g., initial vertex) in the crease group in the bitstream.

In some embodiments, deduplication of the first vertex in the non-first crease within the crease group is applied. For example, in Table 6, the first vertex of the second crease in the first crease group is “8”, and it is duplicated from the last vertex in the previous crease “8”. The system may apply deduplication by removing the first vertex in the non-first crease within the crease group. The result is shown in Table 7.

TABLE 7
Crease attributes of Table 6 after deduplication

I 1 2 7 8
I 5
I 4 3 8 7
I 8 3
I 2
I 4 5 6

After grouping the creases into crease groups, two parts of the crease attributes need to be coded. They are listed as follows: number of vertices in each crease, and vertices in each crease.

Using Table 6 as an example, the number of vertices in each crease is [4, 2, 5, 3, 2, 3]. Vertices in each crease are [1 2 7 8 8 5 5 4 3 8 7 7 8 3 3 2 4 5 6]. Note that the indices of the vertices are used to represent the vertices in the crease. Thus, the system may encode the index of the vertices (e.g., [1 2 7 8 8 5 5 4 3 8 7 7 8 3 3 2 4 5 6]), rather than the positions of the vertices for the crease attributes.

FIG. 6B is a flow diagram illustrating a method 650 of encoding in accordance with some embodiments. The method 650 may be performed at a computing system (e.g., the server system 112, the source device 102, or the electronic device 120) having control circuitry and memory storing instructions for execution by the control circuitry. In some embodiments, the method 650 is performed by executing instructions stored in the memory (e.g., the memory 314) of the computing system. In some embodiments, the method 650 is performed by a same system as the method 600 above.

The system obtains (652) a mesh object. The system signals (654), via a bitstream, a first indicator indicating a number of creases for the mesh object. The system signals (656), via the bitstream, a second indicator indicating a number of vertices for the mesh object. For each crease in the number of creases (658): the system determines (660) whether the crease is an initial crease. When the crease is the initial crease, the system signals (662), via the bitstream, a prediction residue. When the crease is not the initial crease, the system selectively signals (664), via the bitstream, a corresponding prediction residue based on a predictor index. In this way, crease information may be signaled in a bitstream (e.g., an attribute bitstream for a set of mesh objects). As described previously, the encoding process may mirror the decoding processes described herein. For brevity, those details are not repeated here.

Although FIGS. 6A and 6B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments. In the following, eight example methods are described to code these two parts. In summary,

Method 1: Signal is_initial_crease, predictor_index. Using predictor_index<0 to indicate the need for signal pred_residue.

Method 2: Signal is_initial_crease, predictor_index, is_zero_residue. Using is_zero_residue to indicate the need for signal pred_residue.

Method 3: Signal is_initial_crease, predictor_index, pred_residue.

Method 4: Signal is_initial_crease, pred_residue.

Method 5: Signal num_crease_group, predictor_index. Using predictor_index<0 to indicate the need for signal pred_residue.

Method 6: Signal num_crease_group, predictor_index, is_zero_residue. Using is_zero_residue to indicate the need for signal pred_residue.

Method 7: Signal num_crease_group, predictor_index, pred_residue.

Method 8: Signal num_crease_group, pred_residue.

The methods are intended only as illustrative examples. In some embodiments, features of the different methods may be interchanged.

### Example Method 1

Example method 1 encodes the number of creases, the number of vertices in all creases, and the minimum number of vertices in all creases. For each crease, the system encodes the number of vertices within the crease minus the minimum number of vertices in all creases, and encodes if this crease is the initial crease (e.g., the first crease) in the crease group. Note that the system does not need to signal the number of vertices for the last crease, as it can be derived from the total number of vertices of all creases minus the sum of the number of vertices from the first crease to the second-to-last crease.

For each vertex in the creases, if the vertex being coded is the first vertex in a crease group (e.g., the first vertex in the initial crease in a crease group), the system computes predictors for this vertex. Then, the system encodes the predictor index if the number of predictors is greater than one, and encodes the prediction residue. If the vertex being coded is not the first vertex in a crease group but is the first vertex in a crease, e.g., the first vertex in the non-initial crease, the system does not encode it; instead, it can be derived by duplicating the last vertex in the previous crease. If the vertex being coded is not the first vertex in a crease group nor the first vertex in a crease, the system computes the predictors of this vertex, and uses “−1” as a predictor index to indicate that no predictors result in zero residue. The system encodes the predictor index, and if the predictor index is smaller than 0, the system encodes the residue of the prediction value to the index value of the vertex being encoded.

TABLE 8
Example syntax for Example Method 1

| | Descriptor |
|---|---|
| crease_syntax( ) { | |
| num_crease_minus1 | ue(v) |
| num_vertex_minus1 | ue(v) |
| min_num_vertex_crease | ue(v) |
| for( i = 0; c = 0; c <= num_crease_minus1; ++c ) { | |
| is_initial_crease | u(1) |
| if( c < num_crease_minus1 ) | |
| num_vertex_crease_minus_min[ c ] | ue(v) |
| if( is_initial_crease ) { | |
| if( NumPredictor > 1 ) | |
| predictor_index | ue(v) |
| pred_residue | se(v) |
| } | |
| EndIndex = i + num_vertex_crease_minus_min[ c ] | |
| + min_num_vertex_crease; | |
| for( ++i; i < EndIndex; ++i ) { | |
| predictor_index | se(v) |
| if( predictor_index < 0 ) | |
| pred_residue | se(v) |
| } //i | |
| } //c | |
| } | |

In Table 8, num_crease_minus1 specifies the total number of creases minus 1. For example, in Table 6, num_crease_minus1 is 5. num_vertex_minus1 specifies the total number of vertices in all the creases minus 1. For example, in Table 2, num_vertex_minus1 is 18. min_num_vertex_crease specifies the minimum number of vertices of all the creases. For example, in Table 6, min_num_vertex_crease is 2. num_vertex_crease_minus_min[c] specifies the number of vertices minus (min_num_vertex_crease) in the cth crease. For example, in Table 6, num_vertex_crease_minus_min[0] is 2, and num_vertex_crease_minus_min[5] is 1. is_initial_crease specifies if the cth crease is the first crease in a crease group. It is “1” (or “true”) if the cth crease is the first crease in a crease group, and it is “0” (or “false”) if the cth crease is not the first crease in a crease group. For example, in Table 6, the is_initial_crease of the first crease is 1, and the is_initial_crease of the second crease is 0. predictor_index specifies the predictor index of one of the predictors used to predict the vertex in the crease. If it is “−1”, it indicates that no predictors result in zero residue. pred_residue specifies the residue of the prediction value of predictor_index to the vertex in the crease. NumPredictor specifies the number of predictors.

Next, an example decoding process is described for Example Method 1. The input to this process is a bitstream of the crease attributes. The output of the process is an array of the numbers of vertices in each crease (i.e., num_vertex_crease_minus_min[c]+min_num_vertex_crease) and an array of the vertices in all creases (i.e., index_vertex_crease[i]).

The decoding process first decodes the number of creases minus one (e.g., num_crease_minus1), the number of vertices in all creases minus one (e.g., num_vertex_minus1), and the minimum number of vertices in all creases (e.g., min_num_vertex_crease).

For each crease, if the crease is not the last crease, it decodes the number of vertices of the crease minus the minimum number of vertices of all creases (e.g., num_vertex_crease_minus_min[c]). If the crease is the last crease, the number of vertices of the crease minus the minimum number of vertices of all creases is derived by the total number of vertices in all creases minus the sum of the number of vertices of all previous creases minus the minimum number of vertices in all creases.

For decoding the first vertex in the crease, it decodes if the crease is the initial crease (e.g., is_initial_crease). If yes, it computes the predictors and decodes the predictor index if the number of predictors is greater than 1. It decodes the prediction residue (e.g., pred_residue) and derives the index of the first vertex (e.g., index_vertex_crease[i]) in this crease by adding the residue to the prediction value obtained by the index-th predictor, and updates the previous initial vertex (e.g., PrevInitVertex) with this derived vertex index. If no, which means the crease is not the initial crease, it derives the index of the first vertex (e.g., index_vertex_crease[i]) in this crease by using the index of the last vertex (e.g., LastVertex). Then, it updates the index of the last vertex with the derived vertex index.

To decode the remaining vertices in the crease, specifically from the second to the last vertex, it computes the predictors and decodes the predictor index (e.g., predictor_index). If the predictor index is bigger than or equal to zero, the index of the vertex is equal to the prediction of the predictor index. If the predictor index is smaller than zero, it means that no predictions have zero residual results. It decodes the prediction residue (e.g., pred_residue) and adds it to the index of the last vertex to derive the index of the vertex.

Snippet 3 - Example Crease Indices Coding

| | |
|---|---|
| LastVertex = −1; | // the index of the last vertex |
| PrevInitVertex = 0; | // the index of the first vertex in the previous crease group |
| IndexCounter = 0; | // the sum of the number of vertices of previous creases |

```
for( i = 0, c = 0; c <= num_crease_minus1; ++c ) {
  if( c < num_crease_minus1 ) {
    IndexCounter += num_vertex_crease_minus_min[ c ] + min_num_vertex_crease;
  } else {
      num_vertex_crease_minus_min[ c ] = num_vertex_minus1 + 1 − IndexCounter −
min_num_vertex_crease;
  }
  if( is_initial_crease ) {
      ComputePredictors( Predictions );
      predictor_index = NumPredictor > 1 ? predictor_index : 0
      index_vertex_crease[ i ] = Predictions[ predictor_index ] + pred_residue;
      PrevInitVertex = index_vertex_crease[ i ];
  } else {
      index_vertex_crease[ i ] = LastVertex;
  }
  LastVertex = index_vertex_crease[ i ];
  EndIndex = i + num_vertex_crease_minus_min[ c ] + min_num_vertex_crease;
  for( ++i; i < EndIndex; ++i ) {
      ComputePredictors( Predictions );
      if( predictor_index >= 0 ) {
        index_vertex_crease[ i ] = Predictions[ predictor_index ];
      } else {
        index_vertex_crease[ i ] = LastVertex + pred_residue;
      }
      LastVertex = index_vertex_crease[ i ];
  }
}
```

In Example Method 1, the system allows multiple predictors for the non-first vertex in a crease.

For the first vertex in the first crease group: The system uses “0” as a predictor and encode the prediction residue. No need to encode the predictor index here since there is only one predictor. Only encoding the prediction residue is needed. In some embodiments, the system uses half of the total number of vertices as a predictor and encode the prediction residue. No need to encode the predictor index here since there is only one predictor. Only encoding the prediction residue is needed.

For the first vertex in a non-first crease group: The system uses the first vertex in the previous crease group as a predictor. No need to encode the predictor index here since there is only one predictor. Only encoding the prediction residue is needed. In some embodiments, the system uses the last vertex in the previous crease group as a predictor. No need to encode the predictor index here since there is only one predictor. Only encoding the prediction residue is needed. In some embodiments, a limited number of the encoded first vertices in the previous crease groups are predictors. The system encodes the predictor index here if the number of predictors is more than 1. Encoding the prediction residue is also required. In some embodiments, a limited number of the encoded last vertices in the previous crease groups are predictors. The system encodes the predictor index here if the number of predictors is more than 1. Encoding the prediction residue is also required. In some embodiments, a limited number of the encoded first and last vertices in the previous crease groups are predictors. The system needs to encode the predictor index here if the number of predictors is more than 1. Encoding the prediction residue is also required.

For the non-first vertex in a crease: All the connected vertices of the previously coded vertex are predictors. The system uses a predictor index equal to “−1” to indicate that the vertex being coded is not one of the connected vertices of the previously coded vertex. If the predictor index is bigger than or equal to 0, the system encodes the predictor index to indicate which connected vertex is the next one. If the predictor index is smaller than 0, the system encodes the prediction residue. If the vertex being coded is not one of the connected vertices of the previously coded vertex (the predictor index is smaller than 0), the system uses the last vertex as a predictor and encode the prediction residue. No need to encode the predictor index here since there is only one predictor. In some embodiments, all the connected vertices of the previously encoded vertex are predictors. Since the crease is composed of connected vertices, the system only needs to encode the predictor index to indicate which connected vertex is the next one. No need to encode prediction residue here.

For the first vertex in a crease but not the first vertex in a crease group: The system does not encode it; instead, it can be derived by duplicating the last vertex in the previous crease.

### Example Method 2

Example Method 2 encodes the number of creases, the number of vertices in all creases, and the minimum number of vertices in all creases. For each crease, the system encodes the number of vertices within the crease minus the minimum number of vertices in all creases, and encodes if this crease is the initial crease (i.e., the first crease) in the crease group. Note that the system does not need to signal the number of vertices for the last crease, as it can be derived from the total number of vertices of all creases minus the sum of the number of vertices from the first crease to the second-to-last crease.

For each vertex in the creases, if the vertex being coded is the first vertex in a crease group, the system computes predictors for this vertex. Then, the system encodes the predictor index if the number of predictors is greater than one, and encode the prediction residue. If the vertex being coded is not the first vertex in a crease group but is the first vertex in a crease, the system does not encode it; instead, it can be derived by duplicating the last vertex in the previous crease. If the vertex being coded is not the first vertex in a crease group nor the first vertex in a crease, the system computes the predictors of this vertex, and uses one bit to indicate that if the predictor results in zero residue. If the predictor results in zero residue, the system encodes the predictor index (if the number of predictors is greater than one), otherwise, the system encodes the residue of the prediction value to the index value of the vertex being encoded.

TABLE 9
Example syntax for Example Method 2

| | Descriptor |
|---|---|
| crease_syntax( ) { | |
| num_crease_minus1 | ue(v) |
| num_vertex_minus1 | ue(v) |
| min_num_vertex_crease | ue(v) |
| for( i = 0; c = 0; c <= num_crease_minus1; ++c ) { | |
| is_initial_crease | u(1) |
| if( c < num_crease_minus1 ) | |
| num_vertex_crease_minus_min[ c ] | ue(v) |
| if( is_initial_crease ) { | |
| if( NumPredictor > 1 ) | |
| predictor_index | ue(v) |
| pred_residue | se(v) |
| } | |
| EndIndex = i + num_vertex_crease_minus_min[ c ] | |
| + min_num_vertex_crease; | |
| for( ++i; i < EndIndex; ++i ) { | |
| if( NumPredictor > 1) | |
| predictor_index | ue(v) |
| is_zero_residue | u(1) |
| if( !is_zero_residue ) | |
| pred_residue | se(v) |
| } //i | |
| } //c | |
| } | |

In Table 9, num_crease_minus1 specifies the total number of creases minus 1. num_vertex_minus1 specifies the total number of vertices in all the creases minus 1. min_num_vertex_crease specifies the minimum number of vertices of all the creases. num_vertex_crease_minus_min[c] specifies the number of vertices minus (min_num_vertex_crease) in the cth crease. is_initial_crease specifies if the cth crease is the first crease in a crease group. It is “1” (or “true”) if the cth crease is the first crease in a crease group, and it is “0” (or “false”) if the cth crease is not the first crease in a crease group. is_zero_residual specifies if the prediction of the ith vertex results in zero residue. predictor_index specifies the predictor index of one of the predictors used to predict the vertex in the crease. pred_residue specifies the residue of the prediction value of predictor_index to the vertex in the crease. NumPredictor specifies the number of predictors.

Next, an example decoding process is described for Example Method 2. The input to this process is a bitstream of the crease attributes. The output of this process is an array of the numbers of vertices in each crease and an array of the vertices in all creases. The decoding process decodes the number of creases minus one, the number of vertices in all creases minus one, and the minimum number of vertices in all creases.

For each crease, if the crease is not the last crease, it decodes the number of vertices of the crease minus the minimum number of vertices of all creases. If the crease is the last crease, the number of vertices of the crease minus the minimum number of vertices of all creases is derived by the total number of vertices in all creases minus the sum of the number of vertices of all previous creases minus the minimum number of vertices in all creases.

For decoding the first vertex in the crease, it decodes if the crease is the initial crease. If yes, it computes the predictors and decodes the predictor index if the number of predictors is greater than 1. It decodes the prediction residue and derives the index of the first vertex in this crease by adding the residue to the prediction value obtained by the index-th predictor, and updates the previous initial vertex with this derived vertex index. If no, which means the crease is not the initial crease, it derives the index of the first vertex in this crease by using the index of the last vertex. Then, it updates the index of the last vertex with the derived vertex index.

To decode the remaining vertices in the crease, specifically from the second to the last vertex, it computes the predictors and decodes the predictor index if the number of predictors is greater than one. It decodes a bit to indicate if the prediction residue is zero. If the prediction residue is zero, the vertex index equals the predictor index's prediction. Conversely, if the prediction residue is not zero, it implies that no predictions yield zero residual results. It decodes the prediction residue and adds it to the last vertex's index to derive the vertex index.

Snippet 4 - Example Crease Indices Coding

| | |
|---|---|
| LastVertex = −1; | // the index of the last vertex |
| PrevInitVertex = 0; | // the index of the first vertex in the previous crease group |
| IndexCounter = 0; | // the sum of the number of vertices of previous creases |

```
for( i = 0, c = 0; c <= num_crease_minus1; ++c ) {
  if( c < num_crease_minus1 ) {
    indexCounter += num_vertex_crease_minus_min[ c ] + min_num_vertex_crease;
  } else {
    num_vertex_crease_minus_min[ c ] = num_vertex_minus1 + 1 − IndexCounter −
min_num_vertex_crease;
  }
  if( is_initial_crease ) {
    ComputePredictors( Predictions );
    predictor_index = NumPredictor > 1 ? predictor_index : 0
    index_vertex_crease[ i ] = Predictions[ predictor_index ] + pred_residue;
    PrevInitVertex = index_vertex_crease[ i ];
  } else {
    index_vertex_crease[ i ] = LastVertex;
  }
  LastVertex = index_vertex_crease[ i ];
  EndIndex = i + num_vertex_crease_minus_min[ c ] + min_num_vertex_crease;
  for( ++i; i < EndIndex; ++i ) {
    ComputePredictors( Predictions );
    predictor_index = NumPredictor > 1 ? predictor_index : 0
    if( is_zero_residual ) {
      index_vertex_crease[ i ] = Predictions[ predictor_index ];
    } else {
      index_vertex_crease[ i ] = Predictions[ predictor_index ] + pred_residue;
    }
    LastVertex = index_vertex_crease[ i ];
  }
```

In Example Method 2, the system allows multiple predictors for the non-first vertex in a crease.

For the first vertex in the firs crease group: The system uses “0” as a predictor and encode the prediction residue. No need to encode the predictor index here since there is only one predictor. Only encoding the prediction residue is needed. In some embodiments, the system uses half of the total number of vertices as a predictor and encode the prediction residue. No need to encode the predictor index here since there is only one predictor. Only encoding the prediction residue is needed.

For the first vertex in a non-first crease group: The system uses the first vertex in the previous crease group as a predictor. No need to encode the predictor index here since there is only one predictor. Only encoding the prediction residue is needed. In some embodiments, the system uses the last vertex in the previous crease group as a predictor. No need to encode the predictor index here since there is only one predictor. Only encoding the prediction residue is needed. In some embodiments, a limited number of the encoded first vertices in the previous crease groups are predictors. The system needs to encode the predictor index here if the number of predictors is more than 1. Encoding the prediction residue is also required. In some embodiments, a limited number of the encoded last vertices in the previous crease groups are predictors. The system needs to encode the predictor index here if the number of predictors is more than 1. Encoding the prediction residue is also required. In some embodiments, a limited number of the encoded first and last vertices in the previous crease groups are predictors. The system needs to encode the predictor index here if the number of predictors is more than 1. Encoding the prediction residue is also required.

For the non-first vertex in a crease: All the connected vertices of the previously coded vertex are predictors. The system uses a bit to indicate that the vertex being coded is not one of the connected vertices of the previously coded vertex. The system encodes the predictor index to indicate which connected vertex is the next one if the vertex being coded is one of the connected vertices of the previously coded vertex. If the vertex being coded is not one of the connected vertices of the previously coded vertex, the system encodes the prediction residue. If the vertex being coded is not one of the connected vertices of the previously coded vertex, the system uses the last vertex as a predictor and encode the prediction residue. No need to encode the predictor index here since there is only one predictor. In some embodiments, if the vertex being coded is not one of the connected vertices of the previously coded vertex, the system selects the predictor that yields the smallest residue, and encodes the predictor index and the prediction residue. In some embodiments, all the connected vertices of the previously encoded vertex are predictors. Since the crease is composed of connected vertices, the system only needs to encode the predictor index to indicate which connected vertex is the next one. No need to encode prediction residue here.

For the first vertex in a crease but not the first vertex in a crease group, the system does not encode it; instead, it can be derived by duplicating the last vertex in the previous crease.

### Example Method 3

Example Method 3 encodes the number of creases, the number of vertices in all creases, and the minimum number of vertices in all creases. For each crease, the system encodes the number of vertices within the crease minus the minimum number of vertices in all creases, and encodes if this crease is the initial crease in the crease group. Note that the system does not need to signal the number of vertices for the last crease, as it can be derived from the total number of vertices of all creases minus the sum of the number of vertices from the first crease to the second-to-last crease. For each vertex in the creases, if the vertex being coded is the first vertex in a crease group, the system computes predictors for this vertex. Then, the system encodes the predictor index if the number of predictors is greater than one, and encodes the prediction residue. If the vertex being coded is not the first vertex in a crease group but is the first vertex in a crease, the system does not encode it; instead, it may be derived by duplicating the last vertex in the previous crease. If the vertex being coded is not the first vertex in a crease group nor the first vertex in a crease, the system computes the predictors of this vertex. This method limits the number of predictors, so it encodes the predictor index if the number of predictors is greater than one, and encodes the residue of the prediction value to the index value of the vertex being encoded.

TABLE 10
Example syntax for Example Method 3

| | Descriptor |
|---|---|
| crease_syntax( ) { | |
| num crease_minus1 | ue(v) |
| num_vertex_minus1 | ue(v) |
| min_num_vertex_crease | ue(v) |
| for( i = 0; c = 0; c <= num_crease_minus1; ++c ) { | |
| is_initial_crease | u(1) |
| if( c < num_crease_minus1 ) | |
| num_vertex_crease_minus_min[ c ] | ue(v) |
| if( is_initial_crease ) { | |
| if( NumPredictor > 1 ) | |
| predictor_index | u(2) |
| pred_residue | se(v) |
| } | |
| EndIndex = i + num_vertex_crease_minus_min[ c ] | |
| + min_num_vertex_crease; | |
| for( ++i; i < EndIndex; ++i ) { | |
| if( NumPredictor > 1 ) | |
| predictor_index | u(2) |
| pred_residue | se(v) |
| } //i | |
| } //c | |
| } | |

In Table 10, num_crease_minus1 specifies the total number of creases minus 1. num_vertex_minus1 specifies the total number of vertices in all the creases minus 1. min_num_vertex_crease specifies the minimum number of vertices of all the creases. num_vertex_crease_minus_min[c] specifies the number of vertices minus (min_num_vertex_crease) in the cth crease. is_initial_crease specifies if the cth crease is the first crease in a crease group. It is “1” (or “true”) if the cth crease is the first crease in a crease group, and it is “0” (or “false”) if the cth crease is not the first crease in a crease group. predictor_index specifies the predictor index of one of the predictors used to predict the vertex in the crease. pred_residue specifies the residue of the prediction value of predictor_index to the vertex in the crease. NumPredictor specifies the number of predictors.

Next, an example decoding process is described for Example Method 3. The input to this process is a bitstream of the crease attributes. The output of this process is an array of the numbers of vertices in each crease and an array of the vertices in all creases. The decoding process first decodes the number of creases minus one, the number of vertices in all creases minus one, and the minimum number of vertices in all creases.

For each crease, if the crease is not the last crease, it decodes the number of vertices of the crease minus the minimum number of vertices of all creases. If the crease is the last crease, the number of vertices of the crease minus the minimum number of vertices of all creases is derived by the total number of vertices in all creases minus the sum of the number of vertices of all previous creases minus the minimum number of vertices in all creases.

For decoding the first vertex in the crease, it decodes if the crease is the initial crease. If yes, it computes the predictors and decodes the predictor index if the number of predictors is greater than 1. It decodes the prediction residue and derives the index of the first vertex in this crease by adding the residue to the prediction value obtained by the index-th predictor, and updates the previous initial vertex with this derived vertex index. If no, which means the crease is not the initial crease, it derives the index of the first vertex in this crease by using the index of the last vertex. Then, it updates the index of the last vertex with the derived vertex index.

To decode the remaining vertices in the crease, specifically from the second to the last vertex, it calculates the predictors and decodes the predictor index if the number of predictors is greater than one, and decodes the prediction residue. The vertex index is determined by adding the prediction residue to the prediction value obtained from the indexth predictor.

Snippet 5 - Example Crease Indices Coding

| | |
|---|---|
| LastVertex = −1; | // the index of the last vertex |
| PrevInitVertex = 0; | // the index of the first vertex in the previous crease group |
| IndexCounter = 0; | // the sum of the number of vertices of previous creases |

```
for( i = 0, c = 0; c <= num_crease_minus1; ++c ) {
  if( c < num_crease_minus1 ) {
    indexCounter += num_vertex_crease_minus_min[ c ] + min_num_vertex_crease;
  } else {
      num_vertex_crease_minus_min[ c ] = num_vertex_minus1 + 1 − IndexCounter −
min_num_vertex_crease;
  }
  if( is_initial_crease ) {
      ComputePredictors( Predictions );
      predictor_index = NumPredictor > 1 ? predictor_index : 0
      index_vertex_crease[ i ] = Predictions[ predictor_index ] + pred_residue;
      PrevInitVertex = index_vertex_crease[ i ];
  } else {
      index_vertex_crease[ i ] = LastVertex;
  }
  LastVertex = index_vertex_crease[ i ];
  EndIndex = i + num_vertex_crease_minus_min[ c ] + min_num_vertex_crease;
  for( ++i; i < EndIndex; ++i ) {
      ComputePredictors( Predictions );
      predictor_index = NumPredictor > 1 ? predictor_index : 0
      index_vertex_crease[ i ] = Predictions[ predictor_index ] + pred_residue;
      LastVertex = index_vertex_crease[ i ];
  }
}
```

In some embodiments, the system uses a fixed length of bits to signal the predictor_index. For example, the system uses 2 bits to signal the predictor_index. Therefore, four predictors are allowed. In some embodiments, the system uses a variable length of bits to signal the predictor_index, as shown in Table 11 below.

TABLE 11
Example Predictor Codewords

| codeword | predictor_index |
|---|---|
| 1 | 0 |
| 01 | 1 |
| 001 | 2 |
| . . . | . . . |
| 0 . . . 1 (total k bins: | k-1 |
| (k-1) 0s followed by a 1) | |
| 0 . . . 0 (total k bins: | k |
| (k) 0s) | |

This method limits the number of predictors for the first vertex in the crease group and the non-first vertex in a crease (non-first in a crease group as well), thus both the predictor index and prediction residue should be signaled.

For the first vertex in the first crease group: The system uses “0” as a predictor. No need to encode the predictor index here since there is only one predictor. Only encoding the prediction residue is needed. In some embodiments, the system uses half of the total number of vertices as a predictor. No need to encode the predictor index here since there is only one predictor. Only encoding the prediction residue is needed.

For the first vertex in the non-first crease group: The system uses the first vertex in the previous crease group as a predictor. No need to encode the predictor index here since there is only one predictor. Only encoding the prediction residue is needed. In some embodiments, the system uses the last vertex in the previous crease group as a predictor. No need to encode the predictor index here since there is only one predictor. Only encoding the prediction residue is needed. In some embodiments, a limited number of the encoded first vertices in the previous crease groups are predictors. The system needs to encode the predictor index here if the number of predictors is more than 1. Encoding the prediction residue is also required. In some embodiments, a limited number of the encoded last vertices in the previous crease groups are predictors. The system needs to encode the predictor index here if the number of predictors is more than 1. Encoding the prediction residue is also required. In some embodiments, a limited number of the encoded first and last vertices in the previous crease groups are predictors. The system needs to encode the predictor index here if the number of predictors is more than 1. Encoding the prediction residue is also required.

For the non-first vertex in a crease: A limited number of the connected vertices of the previously encoded vertex are predictors. The system need to encode the predictor index here if the number of predictors is more than 1. Encoding the prediction residue is also needed.

For the first vertex in a crease but not the first vertex in a crease group, the system does not encode it; instead, it may be derived by duplicating the last vertex in the last crease.

### Example Method 4

Example Method 4 encodes the number of creases, the number of vertices in all creases, and the minimum number of vertices in all creases. For each crease, the system encodes the number of vertices within the crease minus the minimum number of vertices in all creases, and encodes if this crease is the initial crease in the crease group. Note that the system does not need to signal the number of vertices for the last crease, as it can be derived from the total number of vertices of all creases minus the sum of the number of vertices from the first crease to the second-to-last crease.

For each vertex in the creases, if the vertex being coded is the first vertex in a crease group, the system computes a predictor for this vertex and encode the prediction residue. If the vertex being coded is not the first vertex in a crease group but is the first vertex in a crease, the system does not encode it. If the vertex being coded is not the first vertex in a crease group nor the first vertex in a crease, the system computes a predictor of this vertex. This method only uses one default predictor, so it encodes the residue of the prediction value to the index value of the vertex being encoded.

TABLE 12
Example syntax for Example Method 4

| | Descriptor |
|---|---|
| crease_syntax( ) { | |
| num_crease_minus1 | ue(v) |
| num_vertex_minus1 | ue(v) |
| min_num_vertex_crease | ue(v) |
| for( i = 0; c = 0; c <= num_crease_minus1; ++c ) { | |
| is_initial_crease | u(1) |
| if( c < num_crease_minus1 ) | |
| num_vertex_crease_minus_min[ c ] | ue(v) |
| if( is_initial_crease ) { | |
| pred_residue | se(v) |
| } | |
| EndIndex = i + num_vertex_crease_minus_min[ c ] | |
| + min_num_vertex_crease; | |
| for( ++i; i < EndIndex; ++i ) { | |
| pred_residue | se(v) |
| } //i | |
| } //c | |
| } | |

In Table 12, num_crease_minus1 specifies the total number of creases minus 1. num_vertex_minus1 specifies the total number of vertices in all the creases minus 1. min_num_vertex_crease specifies the minimum number of vertices of all the creases. num_vertex_crease_minus_min[c] specifies the number of vertices minus (min_num_vertex_crease) in the cth crease. is_initial_crease specifies if the cth crease is the first crease in a crease group. It is “1” (or “true”) if the cth crease is the first crease in a crease group, and it is “0” (or “false”) if the cth crease is not the first crease in a crease group. pred_residue specifies the residue of the prediction value of predictor_index to the vertex in the crease.

Next, an example decoding process is described for Example Method 4. The input to this process is a bitstream of the crease attributes. The output of this process is an array of the numbers of vertices in each crease and an array of the vertices in all creases.

The decoding process first decodes the number of creases minus one, the number of vertices in all creases minus one, and the minimum number of vertices in all creases. For each crease, if the crease is not the last crease, it decodes the number of vertices of the crease minus the minimum number of vertices of all creases. If the crease is the last crease, the number of vertices of the crease minus the minimum number of vertices of all creases is derived by the total number of vertices in all creases minus the sum of the number of vertices of all previous creases minus the minimum number of vertices in all creases.

For decoding the first vertex in the crease, it decodes if the crease is the initial crease. If yes, it computes a predictor and decodes the prediction residue and derives the index of the first vertex in this crease by adding the residue to the prediction value obtained by the predictor. It updates the previous initial vertex with this derived vertex index. If no, which means the crease is not the initial crease, it derives the index of the first vertex in this crease by using the index of the last vertex. Then, it updates the index of the last vertex with the derived vertex index.

To decode the remaining vertices in the crease, specifically from the second to the last vertex, a default predictor is computed, and the prediction residue is decoded. The index of the vertex is determined by adding the prediction residue to the prediction value obtained from the default predictor.

Snippet 6 - Example Crease Indices Coding

| | |
|---|---|
| LastVertex = −1; | // the index of the last vertex |
| PrevInitVertex = 0; | // the index of the first vertex in the previous crease group |
| IndexCounter = 0; | // the sum of the number of vertices of previous creases |

```
for( i = 0, c = 0; c <= num_crease_minus1; ++c ) {
  if( c < num_crease_minus1 ) {
    indexCounter += num_vertex_crease_minus_min[ c ] + min_num_vertex_crease;
  } else {
      num_vertex_crease_minus_min[ c ] = num_vertex_minus1 + 1 − IndexCounter −
min_num_vertex_crease;
  }
  if( is_initial_crease ) {
      index_vertex_crease[ i ] = PrevInitVertex + pred_residue;
      PrevInitVertex = index_vertex_crease[ i ];
  } else {
      index_vertex_crease[ i ] = LastVertex;
  }
  LastVertex = index_vertex_crease[ i ];
  EndIndex = i + num_vertex_crease_minus_min[ c ] + min_num_vertex_crease;
  for( ++i; i < EndIndex; ++i ) {
      ComputePredictors( Prediction );
      index_vertex_crease[ i ] = Prediction + pred_residue;
      LastVertex = index_vertex_crease[ i ];
  }
}
```

For the first vertex in the first crease group: The system uses “0” as the default predictor. In some embodiments, the system uses half of the total number of vertices as the default predictor.

For the first vertex in the non-first crease group: The system uses the first vertex in the previous crease group as the default predictor. In some embodiments, the system uses the last vertex in the previous crease group as the default predictor. In some embodiments, the system uses the previously encoded vertex as the default predictor. In some embodiments, the system uses the median or average of N encoded first vertices in the previous crease groups as the default predictor. In some embodiments, the system uses use the median or average of N encoded last vertices in the previous crease groups as the default predictor. In some embodiments, the system uses use the median or average of N encoded first and last vertices in the previous crease groups as the default predictor.

For the non-first vertex in a crease: One of the connected vertices of the previously encoded vertex is the default predictor. It can be the Nth one in the predictors. In some embodiments, the system uses the previously encoded vertex as the default predictor. In some embodiments, the system uses the median or average of N previously encoded vertices as the default predictor.

For the first vertex in a crease but not the first vertex in a crease group: The system does not encode it.

### Example Method 5

Example Method 5 encodes the number of crease groups minus 1, the number of creases minus 1, the number of vertices in all creases minus 1, and the minimum number of vertices in all creases. For each crease group, the system encodes the number of creases within the group minus 1. Note that the system does not need to signal the number of creases for the last group, as it can be derived from the total number of creases minus the sum of the number of creases from the first to the second-to-last crease group.

For each crease, it encodes the number of vertices within the crease minus the minimum number of vertices in all creases, and encodes if this crease is the initial crease in the crease group. Note that the system does not need to signal the number of vertices for the last crease, as it can be derived from the total number of vertices of all creases minus the sum of the number of vertices from the first crease to the second-to-last crease.

For each vertex in the creases, if the vertex being coded is the first vertex in a crease group, the system computes predictors for this vertex. Then, the system encodes the predictor index if the number of predictors is greater than one, and encodes the prediction residue. If the vertex being coded is not the first vertex in a crease group but is the first vertex in a crease, the system does not encode it. If the vertex being coded is not the first vertex in a crease group nor the first vertex in a crease, the system computes the predictors of this vertex, and use “−1” as a predictor index to indicate that no predictors result in zero residue. The system encodes the predictor index, and if the predictor index is smaller than 0, the system encodes the residue of the prediction value to the index value of the vertex being encoded.

TABLE 13
Example syntax for Example Method 5

| | Descriptor |
|---|---|
| crease_syntax( ) { | |
| num_crease_group_minus1 | ue(v) |
| num_crease_minus1 | ue(v) |
| num_vertex_minus1 | ue(v) |
| min_num_vertex_crease | ue(v) |
| for( i = 0; c = 0; g = 0; g <= num_crease_group_minus1; g++ ) { | |
| if( g < num_crease_group_minus1 ) | |
| num_crease_in_group_minus1[ g ] | ue(v) |
| EndCreaseIndex = c + num_crease_in_group_minus1[ g ] | |
| for( c <= EndCreaseIndex; c++ ) { | |
| is_initial_crease | u(1) |
| if( c < num_crease_minus1 ) | |
| num_vertex_crease_minus_min[ c ] | ue(v) |
| if( is_initial_crease ) | |
| if( NumPredictor > 1) | |
| predictor_index | ue(v) |
| pred_residue | se(v) |
| EndIndex = i + num_vertex_crease_minus_min[ c ] | |
| + min_num_vertex_crease; | |
| for( ++i; i < EndIndex; ++i ) { | |
| predictor_index | se(v) |
| if( predictor_index < 0 ) | |
| pred_residue | se(v) |
| } | |
| } //i | |
| } //c | |
| } //g | |
| } | |

In Table 13, num_crease_group_minus1 specifies the number of crease groups minus 1. num_crease_minus1 specifies the total number of creases minus 1. num_vertex_minus1 specifies the total number of vertices in all the creases minus 1. min_num_vertex_crease specifies the minimum number of vertices of all the creases. num_crease_in_group_minus1[g] specifies the number of creases in the gth crease group minus 1. num_vertex_crease_minus_min[c] specifies the number of vertices minus (min_num_vertex_crease) in the cth crease. is_initial_crease specifies if the cth crease is the first crease in a crease group. It is “1” (or “true”) if the cth crease is the first crease in a crease group, and it is “0” (or “false”) if the cth crease is not the first crease in a crease group. predictor_index specifies the predictor index of one of the predictors used to predict the vertex in the crease. If it is “−1”, it indicates that no predictors result in zero residue. pred_residue specifies the residue of the prediction value of predictor_index to the vertex in the crease. NumPredictor specifies the number of predictors.

Next, an example decoding process is described for Example Method 5. The input to this process is a bitstream of the crease attributes. The output of this process is an array of the numbers of vertices in each crease and an array of the vertices in all creases. The decoding process first decodes the number of crease groups minus one, the number of creases minus one, the number of vertices in all creases minus one, and the minimum number of vertices in all creases.

For each crease group, if it is not the last crease group, it decodes the number of creases within the group minus 1. If it is the last crease group, the number of creases within the group minus 1 is derived by the number of creases minus 1 minus the sum of the number of creases of all previous crease groups.

For each crease, if the crease is not the last crease, it decodes the number of vertices of the crease minus the minimum number of vertices of all creases. If the crease is the last crease, the number of vertices of the crease minus the minimum number of vertices of all creases is derived by the total number of vertices in all creases minus the sum of the number of vertices of all previous creases minus the minimum number of vertices in all creases.

For decoding the first vertex in the crease, it decodes if the crease is the initial crease. If yes, it computes the predictors and decodes the predictor index if the number of predictors is greater than 1. It decodes the prediction residue and derives the index of the first vertex in this crease by adding the residue to the prediction value obtained by the index-th predictor, and updates the previous initial vertex with this derived vertex index. If no, which means the crease is not the initial crease, it derives the index of the first vertex in this crease by using the index of the last vertex. Then, it updates the index of the last vertex with the derived vertex index.

For decoding the remaining vertices in the crease, which are the second one to the last one, it computes the predictors and decodes the predictor index. If the predictor index is bigger than or equal to zero, the index of the vertex is equal to the prediction of the predictor index. If the predictor index is smaller than zero, it means that no predictions have zero residual results. It decodes the prediction residue and adds it to the index of the last vertex to derive the index of the vertex.

Snippet 7 - Example Crease Indices Coding

| | |
|---|---|
| LastVertex = −1; | // the index of the last vertex |
| PrevInitVertex = 0; | // the index of the first vertex in the previous crease group |
| IndexCounter = 0; | // the sum of the number of vertices of previous creases |

```
CreaseCounter = 0;
for( i = 0; c = 0; g = 0; g <= num_crease_group_minus1; g++ ) {
  if( g < num_crease_group_minus1 ) {
    CreaseCounter += num_crease_in_group_minus1[ g ] + 1;
  } else {
    num_crease_in_group_minus1[ g ] = num_crease_minus1 − CreaseCounter;
  }
  EndCreaseIndex = g < num_crease_group_minus1 ? CreaseCounter : num_crease_minus1 + 1
  for(c < EndCreaseIndex; ++c ) {
    if( c < num_crease_minus1 ) {
      IndexCounter += num_vertex_crease_minus_min[ c ] + min_num_vertex_crease;
  } else {
      num_vertex_crease_minus_min[ c ] = num_vertex_minus1 + 1 − IndexCounter −
        min_num_vertex_crease;
    }
    is initial crease = c == EndCreaseIndex − num_crease_in_group_minus1[ g ] − 1;
    if( is_initial_crease ) {
      ComputePredictors( Predictions );
      predictor_index = NumPredictor > 1 ? predictor_index : 0
      index_vertex_crease[ i ] = Predictions[ predictor_index ] + pred_residue;
      PrevInitVertex = index_vertex_crease[ i ];
    } else {
      index_vertex_crease[ i ] = LastVertex;
    }
    LastVertex = index_vertex_crease[ i ];
    EndIndex = c < creaseCountMinus1 ? IndexCounter : num_vertex_minus1 + 1;
    for( ++i; i < EndIndex; ++i ) {
      if( predictor_index >= 0 ) {
        ComputePredictors( Predictions );
        index_vertex_crease[ i ] = Predictions[ predictor_index ];
      } else {
        index_vertex_crease[ i ] = LastVertex + pred_residue;
      }
      LastVertex = index_vertex_crease[ i ];
    }
  }
}
```

In this method, the system allows multiple predictors for the non-first vertex in a crease.

For the first vertex in the first crease group: The system uses “0” as a predictor and encode the prediction residue. No need to encode the predictor index here since there is only one predictor. Only encoding the prediction residue is needed. In some embodiments, the system uses half of the total number of vertices as a predictor and encode the prediction residue. No need to encode the predictor index here since there is only one predictor. Only encoding the prediction residue is needed.

For the first vertex in a non-first crease group: The system uses the first vertex in the previous crease group as a predictor. No need to encode the predictor index here since there is only one predictor. Only encoding the prediction residue is needed. In some embodiments, the system uses the last vertex in the previous crease group as a predictor. No need to encode the predictor index here since there is only one predictor. Only encoding the prediction residue is needed. In some embodiments, a limited number of the encoded first vertices in the previous crease groups are predictors. The system needs to encode the predictor index here if the number of predictors is more than 1. Encoding the prediction residue is also required. In some embodiments, a limited number of the encoded last vertices in the previous crease groups are predictors. The system needs to encode the predictor index here if the number of predictors is more than 1. Encoding the prediction residue is also required. In some embodiments, the system uses a limited number of the encoded first and last vertices in the previous crease groups are predictors. The system needs to encode the predictor index here if the number of predictors is more than 1. Encoding the prediction residue is also required.

For the non-first vertex in a crease: All the connected vertices of the previously coded vertex are predictors. The system uses a predictor index equal to “−1” to indicate that the vertex being coded is not one of the connected vertices of the previously coded vertex. If the predictor index is bigger than or equal to 0, the system encodes the predictor index to indicate which connected vertex is the next one. If the predictor index is smaller than 0, the system encodes the prediction residue. If the vertex being coded is not one of the connected vertices of the previously coded vertex (the predictor index is smaller than 0), the system uses the last vertex as a predictor and encodes the prediction residue. No need to encode the predictor index here since there is only one predictor. In some embodiments, all the connected vertices of the previously encoded vertex are predictors. Since the crease is composed of connected vertices, the system only needs to encode the predictor index to indicate which connected vertex is the next one. No need to encode prediction residue here.

For the first vertex in a crease but not the first vertex in a crease group: The system does not encode it.

### Example Method 6

Example Method 6 encodes the number of crease groups minus 1, the number of creases minus 1, the number of vertices in all creases minus 1, and the minimum number of vertices in all creases. For each crease group, the system encodes the number of creases within the group minus 1. The system does not need to signal the number of creases for the last group, as it can be derived from the total number of creases minus the sum of the number of creases from the first to the second-to-last crease group. For each crease, it encodes the number of vertices within the crease minus the minimum number of vertices in all creases, and encodes if this crease is the initial crease (i.e., the first crease) in the crease group. The system does not need to signal the number of vertices for the last crease, as it can be derived from the total number of vertices of all creases minus the sum of the number of vertices from the first crease to the second-to-last crease. For each vertex in the creases, if the vertex being coded is the first vertex in a crease group, the system computes predictors for this vertex. Then, the system encodes the predictor index if the number of predictors is greater than one, and encode the prediction residue. If the vertex being coded is not the first vertex in a crease group but is the first vertex in a crease, the system does not encode it. If the vertex being coded is not the first vertex in a crease group nor the first vertex in a crease, the system computes the predictors of this vertex, and uses one bit to indicate whether the predictor results in zero residue. If the predictor results in zero residue, the system encodes the predictor index (if the number of predictors is greater than one), otherwise, the system encodes the residue of the prediction value to the index value of the vertex being encoded.

TABLE 14
Example syntax for Example Method 6

| | Descriptor |
|---|---|
| crease_syntax( ) { | |
| num_crease_group_minus1 | ue(v) |
| num_crease_minus1 | ue(v) |
| num_vertex_minus1 | ue(v) |
| min_num_vertex_crease | ue(v) |
| for( g = 0; c = 0; i = 0; g <= num_crease_group_minus1; g++ ) { | |
| if( g < num_crease_group_minus1 ) | |
| num_crease_in_group_minus1[ g ] | ue(v) |
| EndCreaseIndex = c + num_crease_in_group_minus1[ g ] | |
| for( c <= EndCreaseIndex; c++ ) { | |
| is_initial_crease | u(1) |
| if( c < num_crease_minus1 ) | |
| num_vertex_crease_minus_min[ c ] | ue(v) |
| if( is_initial_crease ) | |
| if( NumPredictor > 1 ) | |
| predictor_index | ue(v) |
| pred_residue | se(v) |
| EndIndex = i + num_vertex_crease_minus_min[ c ] | |
| + min_num_vertex_crease; | |
| for( ++i; i < EndIndex; ++i ) { | |
| if( NumPredictor > 1) | |
| predictor_index | ue(v) |
| is_zero_residue | u(1) |
| if( !is_zero_residue ) | |
| pred_residue | se(v) |
| } //i | |
| } //c | |
| } //g | |
| } | |

In Table 14, num_crease_group_minus1 specifies the number of crease groups minus 1. num_crease_minus1 specifies the total number of creases minus 1. num_vertex_minus1 specifies the total number of vertices in all the creases minus 1. min_num_vertex_crease specifies the minimum number of vertices of all the creases. num_crease_in_group_minus1 [g] specifies the number of creases in the gth crease group minus 1. num_vertex_crease_minus_min[c] specifies the number of vertices minus (min_num_vertex_crease) in the cth crease. is_initial_crease specifies if the cth crease is the first crease in a crease group. It is “1” (or “true”) if the cth crease is the first crease in a crease group, and it is “0” (or “false”) if the cth crease is not the first crease in a crease group. is_zero_residual specifies if the prediction of the ith vertex results in zero residue. predictor_index specifies the predictor index of one of the predictors used to predict the vertex in the crease. pred_residue specifies the residue of the prediction value of predictor_index to the vertex in the crease. NumPredictor specifies the number of predictors.

Next, an example decoding process is described for Example Method 6. The input to this process is a bitstream of the crease attributes. The output of this process is an array of the numbers of vertices in each crease and an array of the vertices in all creases. The decoding process first decodes the number of crease groups minus one, the number of creases minus one the number of vertices in all creases minus one, and the minimum number of vertices in all creases.

For each crease group, if it is not the last crease group, the system decodes the number of creases within the group minus 1. If it is the last crease group, the number of creases within the group minus 1 is derived by the number of creases minus 1 minus the sum of the number of creases of all previous crease groups. For each crease, if the crease is not the last crease, it decodes the number of vertices of the crease minus the minimum number of vertices of all creases. If the crease is the last crease, the number of vertices of the crease minus the minimum number of vertices of all creases is derived by the total number of vertices in all creases minus the sum of the number of vertices of all previous creases minus the minimum number of vertices in all creases.

For decoding the first vertex in the crease, it decodes if the crease is the initial crease. If yes, it computes the predictors and decodes the predictor index if the number of predictors is greater than 1. It decodes the prediction residue and derives the index of the first vertex in this crease by adding the residue to the prediction value obtained by the index-th predictor, and updates the previous initial vertex with this derived vertex index. If no, which means the crease is not the initial crease, it derives the index of the first vertex in this crease by using the index of the last vertex. Then, it updates the index of the last vertex with the derived vertex index.

To decode the remaining vertices in the crease, specifically from the second to the last vertex, it computes the predictors and decodes the predictor index if the number of predictors is greater than one. It decodes a bit to indicate if the prediction residue is zero. If the prediction residue is zero, the vertex index equals the predictor index's prediction. Conversely, if the prediction residue is not zero, it implies that no predictions yield zero residual results. It decodes the prediction residue and adds it to the last vertex's index to derive the vertex index.

Snippet 8 - Example Crease Indices Coding

| | |
|---|---|
| LastVertex = −1; | // the index of the last vertex |
| PrevInitVertex = 0; | // the index of the first vertex in the previous crease group |
| IndexCounter = 0; | // the sum of the number of vertices of previous creases |

```
CreaseCounter = 0;
for( i = 0; c = 0; g = 0; g <= num_crease_group_minus1; g++ ) {
  if( g < num_crease_group_minus1 ) {
    CreaseCounter += num_crease_in_group_minus1[ g ] + 1;
  } else {
    num_crease_in_group_minus1 [ g ] = num_crease_minus1 − CreaseCounter;
  }
  EndCreaseIndex = g < num_crease_group_minus1 ? CreaseCounter : num_crease_minus1 + 1
  for(c < EndCreaseIndex; ++c ) {
    if( c < num_crease_minus1 ) {
      IndexCounter += num_vertex_crease_minus_min[ c ] + min_num_vertex_crease;
    } else {
      num_vertex_crease_minus_min[ c ] = num_vertex_minus1 + 1 − IndexCounter −
        min_num_vertex_crease;
    }
    is_initial_crease = c == EndCreaseIndex − num_crease_in_group_minus1[ g ] − 1;
    if( is_initial_crease ) {
      Compute Predictors( Predictions );
      predictor_index = NumPredictor > 1 ? predictor_index : 0
      index_vertex_crease[ i ] = Predictions[ predictor_index ] + pred_residue;
      PrevInitVertex = index_vertex_crease[ i ];
    } else {
      index_vertex_crease[ i ] = LastVertex;
    }
    LastVertex = index_vertex_crease[ i ];
    EndIndex = c < creaseCountMinus1 ? IndexCounter : num_vertex_minus1 + 1;
    for( ++i; i < EndIndex; ++i ) {
      ComputePredictors( Predictions );
      predictor_index = NumPredictor > 1 ? predictor_index : 0
      if( is_zero_residual ) {
        index_vertex_crease[ i ] = Predictions[ predictor_index ];
      } else {
        index_vertex_crease[ i ] = Predictions[ predictor_index ] + pred_residue;
      }
      Last Vertex = index_vertex_crease[ i ];
    }
  }
}
```

In this method, the system allows multiple predictors for the non-first vertex in a crease.

For the first vertex in the firs crease group: The system uses “0” as a predictor and encode the prediction residue. No need to encode the predictor index here since there is only one predictor. Only encoding the prediction residue is needed. In some embodiments, the system uses half of the total number of vertices as a predictor and encode the prediction residue. No need to encode the predictor index here since there is only one predictor. Only encoding the prediction residue is needed.

For the first vertex in a non-first crease group: The system uses the first vertex in the previous crease group as a predictor. No need to encode the predictor index here since there is only one predictor. Only encoding the prediction residue is needed. In some embodiments, the system uses the last vertex in the previous crease group as a predictor. No need to encode the predictor index here since there is only one predictor. Only encoding the prediction residue is needed. In some embodiments, a limited number of the encoded first vertices in the previous crease groups are predictors. The system needs to encode the predictor index here if the number of predictors is more than 1. Encoding the prediction residue is also required. In some embodiments, a limited number of the encoded last vertices in the previous crease groups are predictors. The system needs to encode the predictor index here if the number of predictors is more than 1. Encoding the prediction residue is also required. In some embodiments, a limited number of the encoded first and last vertices in the previous crease groups are predictors. The system needs to encode the predictor index here if the number of predictors is more than 1. Encoding the prediction residue is also required.

For the non-first vertex in a crease: All the connected vertices of the previously coded vertex are predictors. The system uses a bit to indicate that the vertex being coded is not one of the connected vertices of the previously coded vertex. The system encodes the predictor index to indicate which connected vertex is the next one if the vertex being coded is one of the connected vertices of the previously coded vertex. If the vertex being coded is not one of the connected vertices of the previously coded vertex, the system encodes the prediction residue. If the vertex being coded is not one of the connected vertices of the previously coded vertex, the system uses the last vertex as a predictor and encode the prediction residue. No need to encode the predictor index here since there is only one predictor. In some embodiments, if the vertex being coded is not one of the connected vertices of the previously coded vertex, the system selects the predictor that yields the smallest residue, and encodes the predictor index and the prediction residue. In some embodiments, all the connected vertices of the previously encoded vertex are predictors. Because the crease is composed of connected vertices, the system only needs to encode the predictor index to indicate which connected vertex is the next one. No need to encode prediction residue here.

For the first vertex in a crease but not the first vertex in a crease group: The system does not encode it.

### Example Method 7

Example Method 7 encodes the number of crease groups minus 1, the number of creases minus 1, the number of vertices in all creases minus 1, and the minimum number of vertices in all creases. For each crease group, the system encodes the number of creases within the group minus 1. The system does not need to signal the number of creases for the last group, as it can be derived from the total number of creases minus the sum of the number of creases from the first to the second-to-last crease group.

For each crease, it encodes the number of vertices within the crease minus the minimum number of vertices in all creases, and encodes if this crease is the initial crease in the crease group. The system does not need to signal the number of vertices for the last crease, as it can be derived from the total number of vertices of all creases minus the sum of the number of vertices from the first crease to the second-to-last crease. For each vertex in the creases, if the vertex being coded is the first vertex in a crease group, the system computes predictors for this vertex. Then, the system encodes the predictor index if the number of predictors is greater than one, and encodes the prediction residue. If the vertex being coded is not the first vertex in a crease group but is the first vertex in a crease, the system does not encode it. If the vertex being coded is not the first vertex in a crease group nor the first vertex in a crease, the system computes the predictors of this vertex. This method limits the number of predictors, so it encodes the predictor index if the number of predictors is greater than one, and encodes the residue of the prediction value to the index value of the vertex being encoded.

TABLE 15
Example syntax for Example Method 7

| | Descriptor |
|---|---|
| crease_syntax( ) { | |
| num_crease_group_minus1 | ue(v) |
| num_crease_minus1 | ue(v) |
| num_vertex_minus1 | ue(v) |
| min_num_vertex_crease | ue(v) |
| for( g = 0; c = 0; i = 0; g <= num_crease_group_minus1; g++ ) { | |
| if( g < num_crease_group_minus1 ) | |
| num_crease_in_group_minus1[ g ] | ue(v) |
| EndCreaseIndex = c + num_crease_in_group_minus1[ g ] | |
| for( c <= EndCreaseIndex; c++ ) { | |
| is_initial_crease | u(1) |
| if( c < num_crease_minus1 ) | |
| num_vertex_crease_minus_min[ c ] | ue(v) |
| if( is_initial_crease ) | |
| if( NumPredictor > 1) | |
| predictor_index | u(2) |
| pred_residue | se(v) |
| EndIndex = i + num_vertex_crease_minus_min[ c ] | |
| + min_num_vertex_crease; | |
| for( ++i; i < EndIndex; ++i ) { | |
| if( NumPredictor > 1) | |
| predictor_index | u(2) |
| pred_residue | se(v) |
| } //i | |
| } //c | |
| } //g | |
| } | |

In Table 15, num_crease_group_minus1 specifies the number of crease groups minus 1. num_crease_minus1 specifies the total number of creases minus 1. num_vertex_minus1 specifies the total number of vertices in all the creases minus 1. min_num_vertex_crease specifies the minimum number of vertices of all the creases. num_crease_in_group_minus1 [g] specifies the number of creases in the gth crease group minus 1. num_vertex_crease_minus_min[c] specifies the number of vertices minus in the cth crease. is_initial_crease specifies if the cth crease is the first crease in a crease group. It is “1” (or “true”) if the cth crease is the first crease in a crease group, and it is “0” (or “false”) if the cth crease is not the first crease in a crease group. predictor_index specifies the predictor index of one of the predictors used to predict the vertex in the crease. pred_residue specifies the residue of the prediction value of predictor_index to the vertex in the crease. NumPredictor specifies the number of predictors.

Next, an example decoding process is described for Example Method 7. The input to this process is a bitstream of the crease attributes. The output of this process is an array of the numbers of vertices in each crease and an array of the vertices in all creases. The decoding process first decodes the number of crease groups minus one, the number of creases minus one, the number of vertices in all creases minus one, and the minimum number of vertices in all creases.

For each crease group, if it is not the last crease group, it decodes the number of creases within the group minus 1. If it is the last crease group, the number of creases within the group minus 1 is derived by the number of creases minus 1 minus the sum of the number of creases of all previous crease groups. For each crease, if the crease is not the last crease, it decodes the number of vertices of the crease minus the minimum number of vertices of all creases. If the crease is the last crease, the number of vertices of the crease minus the minimum number of vertices of all creases is derived by the total number of vertices in all creases minus the sum of the number of vertices of all previous creases minus the minimum number of vertices in all creases. For decoding the first vertex in the crease, it decodes if the crease is the initial crease. If yes, it computes the predictors and decodes the predictor index if the number of predictors is greater than 1. It decodes the prediction residue and derives the index of the first vertex in this crease by adding the residue to the prediction value obtained by the index-th predictor, and updates the previous initial vertex with this derived vertex index. If no, which means the crease is not the initial crease, it derives the index of the first vertex in this crease by using the index of the last vertex. Then, it updates the index of the last vertex with the derived vertex index.

To decode the remaining vertices in the crease, specifically from the second to the last vertex, it calculates the predictors and decodes the predictor index and the prediction residue. The vertex index is determined by adding the prediction residue to the prediction value obtained from the index-th predictor.

Snippet 9 - Example Crease Indices Coding

| | |
|---|---|
| LastVertex = −1; | // the index of the last vertex |
| PrevInitVertex = 0; | // the index of the first vertex in the previous crease group |
| IndexCounter = 0; | // the sum of the number of vertices of previous creases |

```
CreaseCounter = 0;
for(i= 0; c = 0; g = 0; g <= num_crease_group_minus1; g++ ) {
  if( g < num_crease_group_minus1 ) {
    CreaseCounter += num_crease_in_group_minus1[ g ] + 1;
  } else {
    num_crease_in_group_minus1[ g ] = num_crease_minus1 − CreaseCounter;
  }
  EndCreaseIndex = g < num_crease_group_minus1 ? CreaseCounter : num_crease_minus1 + 1
  for(c < EndCreaseIndex; ++c ) {
    if( c < num_crease_minus1 ) {
      IndexCounter += num_vertex_crease_minus_min[ c ] + min_num_vertex_crease;
    } else {
      num_vertex_crease_minus_min[ c ] = num_vertex_minus1 + 1 − IndexCounter -
        min_num_vertex_crease;
    }
    is_initial_crease = c == EndCreaseIndex − num_crease_in_group_minus1[ g ] − 1;
    if( is_initial_crease ) {
      ComputePredictors( Predictions );
      predictor_index = NumPredictor > 1 ? predictor_index : 0
      index_vertex_crease[ i ] = Predictions[ predictor_index ] + pred_residue;
      PrevInitVertex = index_vertex_crease[ i ];
    } else {
      index_vertex_crease[ i ] = LastVertex;
    }
    LastVertex = index_vertex_crease[ i ];
    EndIndex = c < creaseCountMinus1 ? IndexCounter : num_vertex_minus1 + 1;
    for( ++i; i < EndIndex; ++i ) {
      ComputePredictors( Predictions );
      predictor_index = NumPredictor > 1 ? predictor_index : 0
      index_vertex_crease[ i ] = Predictions[ predictor_index ] + pred_residue;
      LastVertex = index_vertex_crease[ i ];
    }
  }
}
```

In some embodiments, the system uses a fixed length of bits to signal the predictor_index. For example, the system uses 2 bits to signal the predictor_index. Therefore, 4 predictors are allowed. In some embodiments, the system uses a variable length of bits to signal the predictor_index, as shown in Table 15 below.

TABLE 15
Example Predictor Codewords

| codeword | predictor_index |
|---|---|
| 1 | 0 |
| 01 | 1 |
| 001 | 2 |
| . . . | . . . |
| 0 . . . 1 (total k bins: | k-1 |
| (k-1) 0s followed by a 1) | |
| 0 . . . 0 (total k bins: | k |
| (k) 0s) | |

This method limits the number of predictors for the first vertex in the crease group and the non-first vertex in a crease (non-first in a crease group as well), thus both the predictor index and prediction residue should be signaled.

For the first vertex in the first crease group: The system uses “0” as a predictor. No need to encode the predictor index here since there is only one predictor. Only encoding the prediction residue is needed. In some embodiments, the system uses half of the total number of vertices as a predictor. No need to encode the predictor index here since there is only one predictor. Only encoding the prediction residue is needed.

For the first vertex in the non-first crease group: The system uses the first vertex in the previous crease group as a predictor. No need to encode the predictor index here since there is only one predictor. Only encoding the prediction residue is needed. In some embodiments, the system uses the last vertex in the previous crease group as a predictor. No need to encode the predictor index here since there is only one predictor. Only encoding the prediction residue is needed. In some embodiments, a limited number of the encoded first vertices in the previous crease groups are predictors. The system needs to encode the predictor index here if the number of predictors is more than 1. Encoding the prediction residue is also required. In some embodiments, a limited number of the encoded last vertices in the previous crease groups are predictors. The system needs to encode the predictor index here if the number of predictors is more than 1. Encoding the prediction residue is also required. In some embodiments, a limited number of the encoded first and last vertices in the previous crease groups are predictors. The system needs to encode the predictor index here if the number of predictors is more than 1. Encoding the prediction residue is also required.

For the non-first vertex in a crease: A limited number of the connected vertices of the previously encoded vertex are predictors. The system need to encode the predictor index here if the number of predictors is more than 1. Encoding the prediction residue is also needed.

For the first vertex in a crease but not the first vertex in a crease group: The system do not encode it.

### Example Method 8

Example Method 8 encodes the number of crease groups minus 1, the number of creases minus 1, the number of vertices in all creases minus 1, and the minimum number of vertices in all creases.

For each crease group, the system encodes the number of creases within the group minus 1. The system does not need to signal the number of creases for the last group, as it can be derived from the total number of creases minus the sum of the number of creases from the first to the second-to-last crease group.

For each crease, it encodes the number of vertices within the crease minus the minimum number of vertices in all creases, and encodes if this crease is the initial crease in the crease group. The system does not need to signal the number of vertices for the last crease, as it can be derived from the total number of vertices of all creases minus the sum of the number of vertices from the first crease to the second-to-last crease.

For each vertex in the creases, if the vertex being coded is the first vertex in a crease group, the system computes predictors for this vertex. Then, the system encodes the predictor index if the number of predictors is greater than one, and encodes the prediction residue. If the vertex being coded is not the first vertex in a crease group but is the first vertex in a crease, the system does not encode it. If the vertex being coded is not the first vertex in a crease group nor the first vertex in a crease, the system computes a predictor of this vertex. This method only uses one default predictor, so it encodes the residue of the prediction value to the index value of the vertex being encoded.

TABLE 17
Example syntax for Example Method 8

| | Descriptor |
|---|---|
| crease_syntax( ) { | |
| num_crease_group_minus1 | ue(v) |
| num_crease_minus1 | ue(v) |
| num_vertex_minus1 | ue(v) |
| min_num_vertex_crease | ue(v) |
| for( g = 0; c = 0; i = 0; g <= num_crease_group_minus1; g++ ) { | |
| if( g < num_crease_group_minus1 ) | |
| num_crease_in_group_minus1[ g ] | ue(v) |
| EndCreaseIndex = c + num_crease_in_group_minus1[ g ] | |
| for( c <= EndCreaseIndex; c++ ) { | |
| is initial crease | u(1) |
| if( c < num_crease_minus1 ) | |
| num_vertex_crease_minus_min[ c ] | ue(v) |
| if( is_initial_crease ) | |
| pred_residue | se(v) |
| EndIndex = i + num_vertex_crease_minus_min[ c ] | |
| + min_num_vertex_crease; | |
| for( ++i; i < EndIndex; ++i ) { | |
| pred_residue | se(v) |
| } //i | |
| } //c | |
| } //g | |
| } | |

In Table 17, num_crease_group_minus1 specifies the number of crease groups minus 1. num_crease_minus1 specifies the total number of creases minus 1. num_vertex_minus1 specifies the total number of vertices in all the creases minus 1. min_num_vertex_crease specifies the minimum number of vertices of all the creases. num_crease_in_group_minus1[g] specifies the number of creases in the gth crease group minus 1. num_vertex_crease_minus_min[c] specifies the number of vertices minus (min_num_vertex_crease) in the cth crease. is_initial_crease specifies if the cth crease is the first crease in a crease group. It is “1” (or “true”) if the cth crease is the first crease in a crease group, and it is “0” (or “false”) if the cth crease is not the first crease in a crease group. pred_residue specifies the residue of the prediction value of predictor_index to the vertex in the crease.

Next, an example decoding process is described for Example Method 8. The input to this process is a bitstream of the crease attributes. The output of this process is an array of the numbers of vertices in each crease and an array of the vertices in all creases. The decoding process first decodes the number of crease groups minus one, the number of creases minus one, the number of vertices in all creases minus one, and the minimum number of vertices in all creases.

For each crease group, if it is not the last crease group, it decodes the number of creases within the group minus 1. If it is the last crease group, the number of creases within the group minus 1 is derived by the number of creases minus 1 minus the sum of the number of creases of all previous crease groups. For each crease, if the crease is not the last crease, it decodes the number of vertices of the crease minus the minimum number of vertices of all creases. If the crease is the last crease, the number of vertices of the crease minus the minimum number of vertices of all creases is derived by the total number of vertices in all creases minus the sum of the number of vertices of all previous creases minus the minimum number of vertices in all creases.

For decoding the first vertex in the crease, it decodes if the crease is the initial crease. If yes, it computes the predictors and decodes the predictor index if the number of predictors is greater than 1. It decodes the prediction residue and derives the index of the first vertex in this crease by adding the residue to the prediction value obtained by the index-th predictor, and updates the previous initial vertex with this derived vertex index. If no, which means the crease is not the initial crease, it derives the index of the first vertex in this crease by using the index of the last vertex. Then, it updates the index of the last vertex with the derived vertex index.

To decode the remaining vertices in the crease, specifically from the second to the last vertex, a default predictor is computed, and the prediction residue is decoded. The index of the vertex is determined by adding the prediction residue to the prediction value obtained from the default predictor.

Snippet 10 - Example Crease Indices Coding

| | |
|---|---|
| LastVertex = −1; | // the index of the last vertex |
| PrevInitVertex = 0; | // the index of the first vertex in the previous crease group |
| IndexCounter = 0; | // the sum of the number of vertices of previous creases |

```
CreaseCounter = 0;
for( i = 0; c = 0; g = 0; g <= num_crease_group_minus1; g++ ) {
  if( g < num_crease_group_minus1 ) {
    CreaseCounter += num_crease_in_group_minus1[ g ] + 1;
  } else {
    num_crease_in_group_minus1[ g ] = num_crease_minus1 − CreaseCounter;
  }
  EndCreaseIndex = g < num_crease_group_minus1 ? CreaseCounter : num_crease_minus1 + 1
  for(c < EndCreaseIndex; ++c ) {
    if( c < num_crease_minus1 ) {
      IndexCounter += num_vertex_crease_minus_min[ c ] + min_num_vertex_crease;
    } else {
      num_vertex_crease_minus_min[ c ] = num_vertex_minus1 + 1 − IndexCounter −
        min_num_vertex_crease;
    }
    is_initial_crease = c == EndCreaseIndex − num_crease_in_group_minus1[ g ] − 1;
    if( is_initial_crease ) {
      ComputePredictors( Prediction );
      index_vertex_crease[ i ] = Prediction + pred_residue;
      PrevInitVertex = index_vertex_crease[ i ];
    } else {
      index_vertex_crease[ i ] = LastVertex;
    }
    LastVertex = index_vertex_crease[ i ];
    EndIndex = c < creaseCountMinus1 ? IndexCounter : num_vertex_minus1 + 1;
    for( ++i; i < EndIndex; ++i ) {
      ComputePredictors( Prediction );
      index_vertex_crease[ i ] = Prediction + pred_residue;
      LastVertex = index_vertex_crease[ i ];
    }
  }
}
```

For the first vertex in the first crease group: The system uses “0” as the default predictor. In some embodiments, the system uses half of the total number of vertices as the default predictor.

For the first vertex in the non-first crease group: The system uses the first vertex in the previous crease group as the default predictor. In some embodiments, the system uses the last vertex in the previous crease group as the default predictor. In some embodiments, the system uses the previously encoded vertex as the default predictor. In some embodiments, the system uses the median or average of N encoded first vertices in the previous crease groups as the default predictor. In some embodiments, the system uses the median or average of N encoded last vertices in the previous crease groups as the default predictor. In some embodiments, the system uses the median or average of N encoded first and last vertices in the previous crease groups as the default predictor.

For the non-first vertex in a crease: One of the connected vertices of the previously encoded vertex is the default predictor. It can be the Nth one in the predictors. In some embodiments, the system uses the previously encoded vertex as the default predictor. In some embodiments, the system uses the median or average of N previously encoded vertices as the default predictor.

For the first vertex in a crease but not the first vertex in a crease group: the system does not encode it.

(A1) In one aspect, some embodiments include a decoding method (e.g., the method 600). In some embodiments, the method is performed at a computing system (e.g., the server system 112) having memory and control circuitry. In some embodiments, the method is performed at a coding module (e.g., the coding module 320). In some embodiments, the method is performed at a coding engine (e.g., the coding engine 212). The method includes (i) receiving a bitstream associated with a mesh object; (ii) parsing a first indicator indicating a number of creases for the mesh object; (iii) parsing a second indicator indicating a number of vertices for the mesh object; and (iv) for each crease in the number of creases: (a) determining whether the crease is an initial crease; (b) when the crease is the initial crease, parsing a prediction residue; and (c) when the crease is not the initial crease, selectively parsing a corresponding prediction residue based on a predictor index.

(A2) In some embodiments of A1, the method further comprises grouping the number of creases into a set of crease groups, wherein each cease group comprises connected creases for the mesh object.

(A3) In some embodiments of A2, grouping the number of creases comprises: (i) for each crease in the number of creases, when a first vertex is bigger than a last vertex, reversing an ordering of the vertices for the crease; (ii) sorting creases of the number of creases based on respective first vertices; (iii) identifying a first unassigned crease from the number of creases;

identifying a second unassigned crease whose first vertex is the same as a last vertex of the first unassigned crease; and (iv) grouping the first unassigned crease with the second unassigned crease in a first group.

(A4) In some embodiments of any of A1-A3, each vertex in the number of vertices is signaled using an index of the vertex.

(A5) In some embodiments of any of A1-A4, the method further comprises parsing a third indicator indicating a minimum number of vertices for creases of the number of creases.

(A6) In some embodiments of A5, the method further comprises parsing a fourth indicator indicating, for a particular crease of the number of creases, a difference from the minimum number of vertices.

(A7) In some embodiments of any of A1-A6, the method further comprises, when the crease is the initial crease, when the number of predictors is greater than one, parsing from the bitstream a third indicator indicating an index for a predictor of the crease.

(A8) In some embodiments of any of A1-A7, the method further comprises, when the crease is not the initial crease, parsing from the bitstream a third indicator indicating the predictor index for the crease.

(B1) In another aspect, some embodiments include an encoding method (e.g., the method 650). In some embodiments, the method is performed at a computing system (e.g., the server system 112) having memory and control circuitry. In some embodiments, the method is performed at a coding module (e.g., the coding module 320). The method includes: (i) obtaining a mesh object; (ii) signaling, via a bitstream, a first indicator indicating a number of creases for the mesh object; (iii) signaling, via the bitstream, a second indicator indicating a number of vertices for the mesh object; and (iv) for each crease in the number of creases: (a) determining whether the crease is an initial crease; (b) when the crease is the initial crease, signaling, via the bitstream, a prediction residue; and (c) when the crease is not the initial crease, selectively signaling, via the bitstream, a corresponding prediction residue based on a predictor index.

(B2) In some embodiments of B1, the method further comprises grouping the number of creases into a set of crease groups, where each cease group comprises connected creases for the mesh object.

(B3) In some embodiments of B2, grouping the number of creases comprises: (i) for each crease in the number of creases, when a first vertex is bigger than a last vertex, reversing an ordering of the vertices for the crease; (ii) sorting creases of the number of creases based on respective first vertices; (iii) identifying a first unassigned crease from the number of creases; (iv) identifying a second unassigned crease whose first vertex is the same as a last vertex of the first unassigned crease; and (v) grouping the first unassigned crease with the second unassigned crease in a first group.

(B4) In some embodiments of any of B1-B3, each vertex in the number of vertices is signaled using an index of the vertex.

(B5) In some embodiments of any of B1-B4, the method further comprises signaling, via the bitstream, a third indicator indicating a minimum number of vertices for creases of the number of creases.

(B6) In some embodiments of B5, the method further comprises signaling, via the bitstream, a fourth indicator indicating, for a particular crease of the number of creases, a difference from the minimum number of vertices.

(B7) In some embodiments of any of B1-B6, the method further comprises, when the crease is the initial crease, when the number of predictors is greater than one, signaling, via the bitstream, a third indicator indicating an index for a predictor of the crease.

(B8) In some embodiments of any of B1-B7, the method further comprises, when the crease is not the initial crease, signaling, via the bitstream, a third indicator indicating the predictor index for the crease.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A8 and B1-B8 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A8, and B1-B8 above). In some embodiments, a memory or non-transitory computer-readable storage medium stores a video bitstream including any of the features (e.g., syntax and encoded information) disclosed herein.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of mesh decoding performed at a computing system having memory and one or more processors, the method comprising:
receiving a bitstream associated with a mesh object;
parsing a first indicator indicating a number of creases for the mesh object;
parsing a second indicator indicating a number of vertices for the mesh object; and
for each crease in the number of creases:
determining whether the crease is an initial crease;
when the crease is the initial crease, parsing a prediction residue; and
when the crease is not the initial crease, selectively parsing a corresponding prediction residue based on a predictor index.

2. The method of claim 1, further comprising grouping the number of creases into a set of crease groups, wherein each cease group comprises connected creases for the mesh object.

3. The method of claim 2, wherein grouping the number of creases comprises:
for each crease in the number of creases, when a first vertex is bigger than a last vertex, reversing an ordering of the vertices for the crease;
sorting creases of the number of creases based on respective first vertices;
identifying a first unassigned crease from the number of creases;
identifying a second unassigned crease whose first vertex is the same as a last vertex of the first unassigned crease; and
grouping the first unassigned crease with the second unassigned crease in a first group.

4. The method of claim 1, wherein each vertex in the number of vertices is signaled using an index of the vertex.

5. The method of claim 1, further comprising parsing a third indicator indicating a minimum number of vertices for creases of the number of creases.

6. The method of claim 5, further comprising parsing a fourth indicator indicating, for a particular crease of the number of creases, a difference from the minimum number of vertices.

7. The method of claim 1, further comprising, when the crease is the initial crease:
when the number of predictors is greater than one, parsing from the bitstream a third indicator indicating an index for a predictor of the crease.

8. The method of claim 1, further comprising, when the crease is not the initial crease:
parsing from the bitstream a third indicator indicating the predictor index for the crease.

9. A method of mesh encoding performed at a computing system having memory and one or more processors, the method comprising:
obtaining a mesh object;
signaling, via a bitstream, a first indicator indicating a number of creases for the mesh object;
signaling, via the bitstream, a second indicator indicating a number of vertices for the mesh object; and
for each crease in the number of creases:
determining whether the crease is an initial crease;
when the crease is the initial crease, signaling, via the bitstream, a prediction residue; and
when the crease is not the initial crease, selectively signaling, via the bitstream, a corresponding prediction residue based on a predictor index.

10. The method of claim 9, further comprising grouping the number of creases into a set of crease groups, wherein each cease group comprises connected creases for the mesh object.

11. The method of claim 10, wherein grouping the number of creases comprises:
for each crease in the number of creases, when a first vertex is bigger than a last vertex, reversing an ordering of the vertices for the crease;
sorting creases of the number of creases based on respective first vertices;
identifying a first unassigned crease from the number of creases;
identifying a second unassigned crease whose first vertex is the same as a last vertex of the first unassigned crease; and
grouping the first unassigned crease with the second unassigned crease in a first group.

12. The method of claim 9, wherein each vertex in the number of vertices is signaled using an index of the vertex.

13. The method of claim 9, further comprising signaling, via the bitstream, a third indicator indicating a minimum number of vertices for creases of the number of creases.

14. The method of claim 13, further comprising signaling, via the bitstream, a fourth indicator indicating, for a particular crease of the number of creases, a difference from the minimum number of vertices.

15. The method of claim 9, further comprising, when the crease is the initial crease:
when the number of predictors is greater than one, signaling, via the bitstream, a third indicator indicating an index for a predictor of the crease.

16. The method of claim 9, further comprising, when the crease is not the initial crease:
signaling, via the bitstream, a third indicator indicating the predictor index for the crease.

17. A non-transitory computer-readable storage medium storing a bitstream that is generated by a mesh encoding method, the bitstream comprising:
a first indicator indicating a number of creases for a mesh object;
a second indicator indicating a number of vertices for the mesh object; and
a third indicator indicating whether each crease in the number of creases is an initial crease.

18. The non-transitory computer-readable storage medium of claim 17, wherein the bitstream further comprises:
for an initial crease in the number of creases, a fourth indicator indicating a prediction residue.

19. The non-transitory computer-readable storage medium of claim 17, wherein the bitstream further comprises:
for a non-initial crease in the number of creases, a fourth indicator indicating a predictor index for the non-initial crease.

20. The non-transitory computer-readable storage medium of claim 19, wherein, when the predictor index for the non-initial crease is greater than zero, the bitstream further comprises a fifth indicator indicating a prediction residue for the non-initial crease.
